(19) United States
(12) Patent Application Publication
(10) Pub. No.: US 2025/0317666 A1
(43) Pub. Date: Oct. 9, 2025

(54) IMAGING DEVICE AND CAMERA SYSTEM

(71) Applicant: Panasonic Intellectual Property Management Co., Ltd., Osaka (JP)

(72) Inventors: HIROAKI IIJIMA, Nara (JP); MASUMI IZUCHI, Osaka (JP); JUNJI HIRASE, Osaka (JP)

(21) Appl. No.: 19/246,248

(22) Filed: Jun. 23, 2025

Related U.S. Application Data
(63) Continuation of application No. PCT/JP2023/042399, filed on Nov. 27, 2023.

(30) Foreign Application Priority Data
Jan. 18, 2023 (JP) 2023-005961

(51) Int. Cl. H04N 25/77; H04N 23/21; H04N 23/56; H04N 23/667; H04N 25/532; H04N 25/709

(52) U.S. Cl. CPC H04N 25/77; H04N 23/667; H04N 25/532; H04N 25/709; H04N 23/21; H04N 23/56

(57) ABSTRACT

An imaging device includes a photoelectric converter including a first electrode, a second electrode facing the first electrode, and a photoelectric conversion layer located between the first electrode and the second electrode, a first voltage supply circuit that applies a voltage between the first electrode and the second electrode, a charge accumulator that is connected to the first electrode and in which electric charge generated by the photoelectric converter is stored, a signal detection circuit that detects a signal based on the electric charge stored in the charge accumulator, at least one current measurement circuit that measures an electric current flowing through the photoelectric converter, and a current change detection circuit that detects a change in the electric current, the electric current flowing through the photoelectric converter and being measured by the at least one current measurement circuit.

### BACKGROUND

### 1. Technical Field

The present disclosure relates to an imaging device and a camera system.

### 2. Description of the Related Art

There have conventionally been known photoelectric conversion image sensors. For example, as image sensors, CMOS (complementary metal-oxide semiconductor) image sensors having photodiodes have been widely used. Features of the CMOS image sensors include low power consumption and pixel-by-pixel accessibility. In general, the CMOS image sensors adopt, as a signal readout method, a so-called rolling shutter method in which exposures and signal charge readouts are performed in sequence for each separate row of a pixel array.

In the rolling shutter method, the starts and ends of exposures vary from one row of the pixel array to another. Therefore, imaging an object moving at high speed may give a distorted image of the object, or using the flash may result in a difference in brightness within an image.

Under such circumstances, there is demand for a so-called global shutter function with which to start and end exposures at the same time for all pixels in the pixel array.

For example, Japanese Patent No. 6799784 discloses a method for, in a stacked image sensor whose circuit components and photoelectric converters are separate from each other, achieving a global shutter function by changing a voltage that is supplied to the photoelectric converters and thereby controlling the migration of signal charge from the photoelectric converters to charge storage regions.

Further, Japanese Unexamined Patent Application Publication No. 2020-57949 proposes an asynchronous solid imaging device called an “event-driven sensor” and a “dynamic vision sensor” that, when an amount of light received exceeds a threshold, detects it as an event for each pixel.

### SUMMARY

In one general aspect, the techniques disclosed here feature an imaging device including a photoelectric converter including a first electrode, a second electrode facing the first electrode, and a photoelectric conversion layer located between the first electrode and the second electrode, a first voltage supply circuit that applies a voltage between the first electrode and the second electrode, a charge accumulator that is connected to the first electrode and in which electric charge generated by the photoelectric converter is stored, a signal detection circuit that detects a signal based on the electric charge stored in the charge accumulator, at least one current measurement circuit that measures an electric current flowing through the photoelectric converter, and a current change detection circuit that detects a change in the electric current, the electric current flowing through the photoelectric converter and being measured by the at least one current measurement circuit.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram showing an example of a camera system according to an embodiment;

FIG. 2 is a schematic view showing an exemplary circuit configuration of an imaging element according to the embodiment;

FIG. 3 is a cross-sectional view schematically showing an exemplary device structure of each pixel according to the embodiment;

FIG. 4 is a plan view showing an example of a planar layout of pixel electrodes and a shield electrode according to the embodiment;

FIG. 5 is a diagram showing an example of an absorbing spectrum in a photoelectric conversion layer containing tin naphthalocyanine;

FIG. 6 is a cross-sectional view schematically showing an example of a configuration of a photoelectric conversion layer according to the embodiment;

FIG. 7 is a diagram showing an exemplary photocurrent characteristic of a photoelectric converter according to the embodiment;

FIG. 8 is a diagram for explaining an example of an operation of normal imaging driving in an imaging device according to the embodiment;

FIG. 9 is a schematic view for explaining the placement of current measurement circuits according to the embodiment;

FIG. 10A is a diagram for explaining specific examples of an operation of current change detection driving in the imaging device according to the embodiment and detection results;

FIG. 10B is a diagram for explaining specific examples of the operation of current change detection driving in the imaging device according to the embodiment and detection results;

FIG. 11 is a diagram for explaining a first example of drive mode control in the imaging device according to the embodiment;

FIG. 12 is a diagram for explaining a second example of drive mode control in the imaging device according to the embodiment; and

FIG. 13 is a diagram for explaining a third example of drive mode control in the imaging device according to the embodiment.

### DETAILED DESCRIPTIONS

An imaging device that can detect a change in a subject such as movement of an object in addition to taking a normal image is useful.

One non-limiting and exemplary embodiment provides an imaging device and a camera system that can detect a change in a subject.

### Brief Overview of the Present Disclosure

As a brief overview of the present disclosure, the following gives examples of an imaging device and a camera system according to the present disclosure.

An imaging device according to a first aspect of the present disclosure includes a photoelectric converter including a first electrode, a second electrode facing the first electrode, and a photoelectric conversion layer located between the first electrode and the second electrode, a first voltage supply circuit that applies a voltage between the first electrode and the second electrode, a charge accumulator that is connected to the first electrode and in which electric charge generated by the photoelectric converter is stored, a signal detection circuit that detects a signal based on the electric charge stored in the charge accumulator, at least one current measurement circuit that measures an electric current flowing through the photoelectric converter, and a current change detection circuit that detects a change in the electric current, the electric current flowing through the photoelectric converter and being measured by the at least one current measurement circuit.

With this, in a case where there is a change in a subject within a range of imaging of the imaging device, there is also a change in the amount of light that is incident on the photoelectric converter, so that there is a change in the electric current flowing through the photoelectric converter. Therefore, in the imaging device according to the present aspect, the current change detection circuit can detect the change in the subject by detecting the change in the electric current, measured by the current measurement circuit, that flows through the photoelectric converter.

Further, for example, an imaging device according to a second aspect of the present disclosure may be directed to the imaging device according to the first aspect. In the imaging device according to the second aspect, the first voltage supply circuit may apply the voltage between the first electrode and the second electrode by supplying a predetermined voltage to the second electrode, and the at least one current measurement circuit may include at least one first current measurement circuit connected to the second electrode.

This makes it possible to detect the change in the electric current by measuring the electric current with a wire connected to the second electrode, to which the predetermined voltage is applied from the first voltage supply circuit, thus making it possible to inhibit circuits of the imaging device from becoming complex.

Further, for example, an imaging device according to a third aspect of the present disclosure may be directed to the imaging device according to the second aspect. In the imaging device according to the third aspect, the second electrode may be divided into a plurality of sub-second electrodes, the at least one first current measurement circuit may include a plurality of first current measurement circuits, and each of the plurality of sub-second electrodes may be connected to a corresponding one of the plurality of first current measurement circuits.

This makes it possible to detect the change in the subject with the imaging device imaging divided regions.

Further, for example, an imaging device according to a fourth aspect of the present disclosure may be directed to the imaging device according to any one of the first to third aspects. In the imaging device according to the fourth aspect, the photoelectric converter may further include a third electrode facing the second electrode across the photoelectric conversion layer, and the at least one current measurement circuit may include at least one second current measurement circuit connected to the third electrode.

This makes it possible to detect the change in the electric current by measuring the electric current with a wire connected to the third electrode, which is different from the first electrode connected to the charge accumulator, thus making it possible to inhibit circuits of the imaging device from becoming complex.

Further, for example, an imaging device according to a fifth aspect of the present disclosure may be directed to the imaging device according to the fourth aspect. In the imaging device according to the fifth aspect, the third electrode may be divided into a plurality of sub-third electrodes, the at least one second current measurement circuit may include a plurality of second current measurement circuits, and each of the plurality of sub-third electrodes may be connected to a corresponding one of the plurality of second current measurement circuits.

This makes it possible to detect the change in the subject with the imaging device imaging divided regions.

Further, for example, an imaging device according to a sixth aspect of the present disclosure may be directed to the imaging device according to any one of the first to fifth aspects. The imaging device according to the sixth aspect may further include a second voltage supply circuits that supplies a predetermined voltage to the charge accumulator. The at least one current measurement circuit may include at least one third current measurement circuit connected to the second voltage supply circuit.

This makes it possible to detect the change in the electric current by measuring the electric current with a wire connected to the second voltage supply circuit, which supplies the voltage to the charge accumulator, thus making it possible to inhibit circuits of the imaging device from becoming complex.

Further, for example, an imaging device according to a seventh aspect of the present disclosure may be directed to the imaging device according to the sixth aspect. The imaging device according to the seventh aspect may further include a plurality of pixels. In the imaging device according to the seventh aspect, each of the plurality of pixels may include the photoelectric converter, the signal detection circuit, and the charge accumulator. The at least one third current measurement circuit may include a plurality of third current measurement circuits. The plurality of pixels may include a first pixel and a second pixel different from the first pixel. The imaging device may further comprise a first wiring path and a second wiring path, the first wiring path connecting the charge accumulator included in the first pixel with the second voltage supply circuit, the second wiring path connecting the charge accumulator included in the second pixel with the second voltage supply circuit. The first wiring path may include a first part that does not overlap the second wiring path, and the second wiring path may include a second part that does not overlap the first wiring path. A corresponding one of the plurality of third current measurement circuits may be located in each of the first part and the second part.

This makes it possible to detect the change in the subject with the imaging device imaging divided regions.

Further, for example, an imaging device according to an eighth aspect of the present disclosure may be directed to the imaging device according to any one of the first to seventh aspects. In the imaging device according to the eighth aspect, the at least one current measurement circuit may include a plurality of current measurement circuits.

This makes it possible to detect the change in the subject with the imaging device imaging divided regions.

Further, for example, an imaging device according to a ninth aspect of the present disclosure may be directed to the imaging device according to any one of the first to eighth aspects. The imaging device according to the ninth aspect may further include a plurality of pixels. In the imaging device according to the ninth aspect, each of the pixels may include the photoelectric converter and the signal detection circuit. The number of the at least one current measurement circuit may be smaller than the number of the plurality of pixels.

This makes low-power-consumption driving possible.

Further, for example, an imaging device according to a tenth aspect of the present disclosure may be directed to the imaging device according to any one of the first to ninth aspects. The imaging device according to the tenth aspect may further include a drive control circuit that controls driving of the imaging device. The drive control circuit may control the imaging device so that the imaging device switches between performing (i) current change detection driving in which the current change detection circuit detects the change in the electric current flowing through the photoelectric converter and performing (ii) normal imaging driving in which the signal detection circuit detects the signal based on the electric charge generated by the photoelectric converter.

With this, the imaging device can detect the change in the subject through the current change detection driving. Meanwhile, in the normal imaging driving, the imaging device can detect a signal for image generation based on the electric charge generated by the photoelectric converter and output a detailed image.

Further, for example, an imaging device according to an eleventh aspect of the present disclosure may be directed to the imaging device according to the tenth aspect. In the imaging device according to the eleventh aspect, in a case where the change in the electric current flowing through the photoelectric converter is detected by the current change detection circuit while the imaging device is performing the current change detection driving, the drive control circuit may switch the driving of the imaging device from the current change detection driving to the normal imaging driving.

This makes it possible to, in a case where the change in the subject has been detected, output, from the imaging device, image data that makes it easier for a user or other persons to identify the subject.

Further, for example, an imaging device according to a twelfth aspect of the present disclosure may be directed to the imaging device according to the eleventh aspect. In the imaging device according to the twelfth aspect, the drive control circuit may switch the driving of the imaging device from the normal imaging driving to the current change detection driving after a predetermined period of time has elapsed since the imaging device started the normal imaging driving.

This makes it possible to reduce power consumption of the imaging device, as normal imaging is performed only for a predetermined period of time since the change in the subject was detected.

Further, for example, an imaging device according to a thirteenth aspect of the present disclosure may be directed to the imaging device according to any one of the tenth to twelfth aspects. In the imaging device according to the thirteenth aspect, while the drive control circuit is controlling the imaging device so that the imaging device performs the current change detection driving, the drive control circuit may bring, into an off state or a stand-by state, at least some of the signal detection circuit and circuits that are connected to the signal detection circuit.

This makes it possible to reduce power consumption of the imaging device in the current change detection driving.

Further, for example, an imaging device according to a fourteenth aspect of the present disclosure may be directed to the imaging device according to the tenth aspect. In the imaging device according to the fourteenth aspect, the drive control circuit may control the imaging device so that the imaging device performs the current change detection driving and the normal imaging driving simultaneously.

This makes it possible to acquire a normal image while detecting the change in the subject.

Further, a camera system according to a fifteenth aspect of the present disclosure includes the imaging device according to any one of the first to fourteenth aspects and a lighting device that emits light containing near infrared radiation.

This makes it possible to detect a change in a subject and acquire an image even in a state such as nighttime where the subject becomes invisible to a human eye.

The following describes the present embodiment in concrete terms with reference to the drawings.

It should be noted that the embodiments to be described below each illustrate a comprehensive and specific example. The numerical values, shapes, materials, constituent elements, placement and topology of constituent elements, steps, orders of steps, or other features that are shown in the following embodiments are just a few examples and are not intended to limit the present disclosure. Further, those of the constituent elements in the following embodiments which are not recited in an independent claim are described as optional constituent elements. Further, the drawings are not necessarily strict illustrations. Further, in the drawings, substantially the same components are given the same reference signs, and a repeated description may be omitted or simplified.

Further, terms used herein to show the way in which elements are interrelated, terms used herein to show the shape of an element, and ranges of numerical values used herein are not expressions that represent only exact meanings but expressions that are meant to also encompass substantially equivalent ranges, e.g. differences of approximately several percent.

Further, the terms “above” and “below” used herein do not refer to an upward direction (upward in a vertical direction) and a downward direction (downward in a vertical direction) in absolute space recognition, but are used as terms that are defined by a relative positional relationship on the basis of an order of stacking in a stack configuration. Specifically, the term “above” refers to a light receiving side of an imaging device, and the term “below” refers to a side of the imaging device that faces away from the light receiving side. It should be noted that terms such as “above” and “below” are used solely to designate the mutual placement of members and are not intended to limit the attitude of the imaging device during use. Further, the terms “above” and “below” are applied not only in a case where two constituent elements are placed at a spacing from each other and another constituent element is present between the two constituent elements, but also in a case where two constituent elements are placed in close contact with each other and the two constituent elements touch each other.

### Embodiment

The following describes an imaging device and a camera system according to the embodiment.

### Camera System

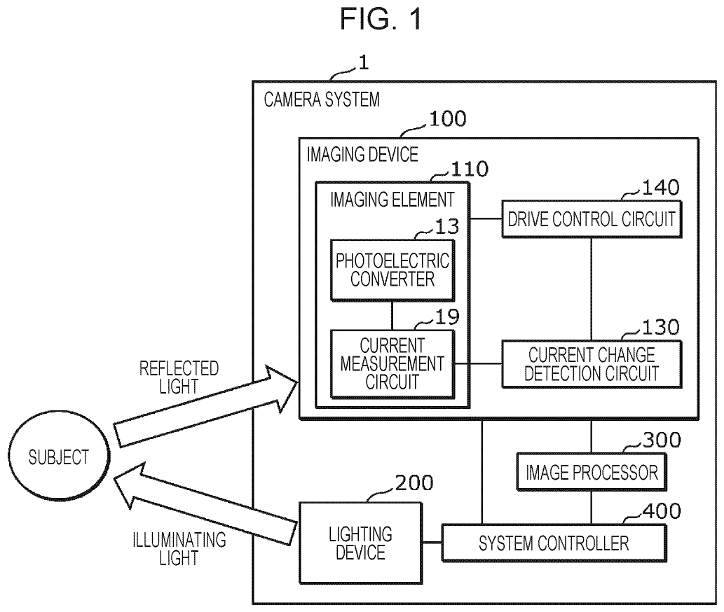

First, a camera system according to the present embodiment is described. FIG. 1 is a block diagram showing an example of a camera system 1 according to the present embodiment.

As shown in FIG. 1, the camera system 1 includes an imaging device 100, a lighting device 200, an image processor 300, and a system controller 400.

In the camera system 1, ambient light and illuminating light emitted by the lighting device 200 are reflected off a subject, and reflected light produced as a result is taken out as an electrical signal by being converted into electric charge by a photoelectric converter of the imaging device 100. In a case where ambient light such as sunlight or exterior lighting is used for imaging, the camera system 1 does not need to include the lighting device 200.

The imaging device 100 includes an imaging element 110, a current change detection circuit 130, and a drive control circuit 140. The imaging element 110 includes a photoelectric converter 13 and outputs a signal based on light falling on the photoelectric converter 13. Further, the imaging element 110 includes a current measurement circuit 19 that is connected to the photoelectric converter 13. The current measurement circuit 19 measures an electric current flowing through the photoelectric converter 13. It should be noted that the current measurement circuit 19 has a circuit element at least part of which may be provided outside the imaging element 110.

The current change detection circuit 130 detects a change in an electric current measured by the current measurement circuit 19. The current change detection circuit 130 can detect the presence of a moving object, for example, based on the change thus detected in the electric current. The drive control circuit 140 controls how the imaging device 100 (particularly the imaging element 110) operates. The current change detection circuit 130 and the drive control circuit 140 are implemented, for example, as one or more microcomputers or processors containing programs for performing processes in the current change detection circuit 130 and the drive control circuit 140, respectively. Alternatively, the current change detection circuit 130 and the drive control circuit 140 may each be implemented, for example, as separate microcomputers or processors or may each be implemented, for example, as one microcomputer or processor. The current change detection circuit 130 and the drive control circuit 140 may include dedicated logic circuits for performing processes in the current change detection circuit 130 and the drive control circuit 140, respectively. The imaging device 100 will be described in detail later.

For example, the lighting device 200 emits, as illuminating light, light containing near infrared radiation. In this case, an electrical signal produced by photoelectric conversion in the photoelectric converter, which has sensitivity to a near-infrared wavelength, of the imaging device 100 is taken out for imaging. A wavelength region of near infrared radiation contained in the illuminating light is, for example, longer than or equal to 680 nm and shorter than or equal to 3000 nm. Alternatively, the wavelength region of near infrared radiation contained in the illuminating light may be longer than or equal to 700 nm and shorter than or equal to 2000 nm or may be longer than or equal to 700 nm and shorter than or equal to 1600 nm. It should be noted that the illuminating light does not need to contain near infrared radiation but may contain at least either visible light or ultraviolet radiation.

Any type of light source may be used in the lighting device 200 as long as the light source can emit light of a desired wavelength. The light source that is used in the lighting device 200 may be, for example, a halogen light source, an LED (light-emitting diode) light source, an organic EL (electroluminescence) light source, a laser diode light source, or other light sources. Further, with the light source that is used in the lighting device 200, a plurality of light sources differing in luminous wavelength from each other may be combined for use. Further, a usable example of a light source that emits light containing near infrared radiation is an inexpensive LED having a peak wavelength longer than or equal to 820 nm and shorter than or equal to 980 nm.

The image processor 300 is a processing circuit that performs various processes on output signals containing image data or other data outputted from the imaging device 100. The image processor 300 performs processes such as gamma correction, color interpolation, spatial interpolation, auto white balance, distance measurement and calculation, and wavelength information separation. For example, the image processor 300 processes output signals from the imaging device 100 and outputs them as images to an external device. The image processor 300 is implemented, for example, as one or more microcomputers or processors containing a program for performing processes in the image processor 300. The image processor 300 may include a dedicated logic circuit for performing processes in the image processor 300. A specific example of the image processor 300 is an ISP (image signal processor).

The system controller 400 exercises overall control of the camera system 1. The system controller 400 controls, for example, the timing of imaging by the imaging device 100 and the timing of emission of the illuminating light by the lighting device 200. The system controller 400 is implemented, for example, as one or more microcomputers or processors containing a program for performing processes in the system controller 400. The system controller 400 may include a dedicated logic circuit for performing processes in the system controller 400.

Although, in the example shown in FIG. 1, the imaging device 100, the lighting device 200, the image processor 300, and the system controller 400 are shown as separate functional blocks, two or more of the imaging device 100, the lighting device 200, the image processor 300, and the system controller 400 may be integrated, for example, by being provided in an identical housing. Further, the image processor 300 and the system controller 400 may each be implemented, for example, as separate microcomputers or processors or may each be implemented, for example, as one microcomputer or processor.

Further, at least some functions of the image processor 300 and the system controller 400 may be possessed by the imaging device 100. For example, at least either the image processor 300 or the system controller 400 may be provided in the imaging device 100. Further, in this case, the current change detection circuit 130, the drive control circuit 140, the image processor 300, and the system controller 400 may each be implemented, for example, as separate microcomputers or processors, and the functions of two or more of them may be implemented, for example, as one microcomputer or processor.

### Imaging Element

Next, the imaging element 110 of the imaging device 100 according to the present embodiment is described in detail.

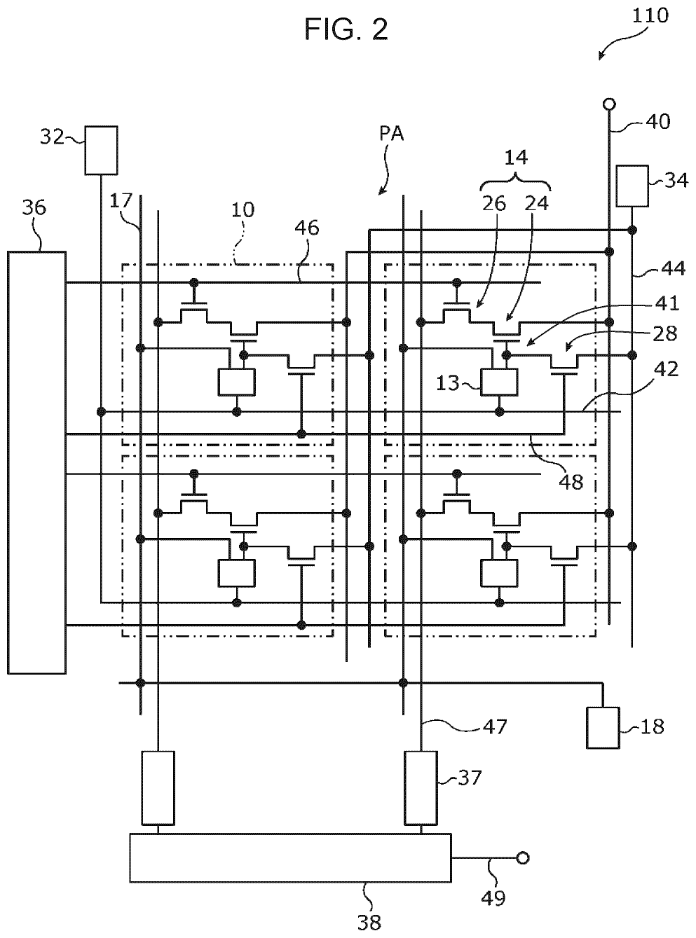

FIG. 2 is a schematic view showing an exemplary circuit configuration of the imaging element 110 according to the present embodiment. It should be noted that FIG. 2 omits to illustrate the current measurement circuit 19. First, a description is given here of a configuration pertaining to the taking of a normal image by the imaging element 110. The current measurement circuit 19 will be described in detail later.

As shown in FIG. 2, the imaging element 110 includes a pixel array PA and peripheral circuits. The pixel array PA includes a plurality of pixels 10 arrayed two-dimensionally, and the peripheral circuits have connections to each pixel 10. The peripheral circuits include, for example, a shield voltage supply circuit 18, a voltage supply circuit 32, a reset voltage source 34, a vertical scanning circuit 36, column signal processing circuits 37, and a horizontal signal readout circuit 38. FIG. 2 schematically shows an example in which the pixels 10 are arranged in two rows and two columns in a matrix. The number and arrangement of pixels 10 in the imaging element 110 are not limited to the example shown in FIG. 2.

Each pixel 10 has a photoelectric converter 13 and a signal detection circuit 14. As will be described later with reference to the drawings, the photoelectric converter 13 has a photoelectric conversion layer sandwiched between two electrodes facing each other and generates signal charge upon receiving incident light. The photoelectric converter 13 does not need to be an element that is independent in its entirety for each pixel 10, and for example, a portion of the photoelectric converter 13 may lie astride a plurality of pixels 10.

The signal detection circuit 14 is a circuit that detects a pixel signal that is an example of a signal based on electric charge generated by the photoelectric converter 13. In the example shown in FIG. 2, the signal detection circuit 14 includes a signal detection transistor 24 and an address transistor 26. The signal detection transistor 24 and the address transistor 26 are, for example, field-effect transistors (FETs), and as the signal detection transistor 24 and the address transistor 26, N-channel MOSFETs (metal-oxide semiconductor field-effect transistors) are illustrated here. Each transistor such as the signal detection transistor 24, the address transistor 26, and the after-mentioned reset transistor 28 has a control terminal, an input terminal, and an output terminal. The control terminal is, for example, a gate. The input terminal is one of a drain and a source and is, for example, the drain. The output terminal is the other of the drain and the source and is, for example, the source.

As schematically shown in FIG. 2, the control terminal of the signal detection transistor 24 has an electrical connection to the photoelectric converter 13. The signal charge generated by the photoelectric converter 13 is stored in a charge storage region including a charge storage node 41 between the gate of the signal detection transistor 24 and the photoelectric converter 13. The signal charge here is a hole and an electron. The charge storage node 41 is also called a “floating diffusion node”. The charge storage node 41 is an example of a charge accumulator. The signal charge is stored in the charge storage region including the charge storage node 41. A structure of the photoelectric converter 13 will be described in detail later.

The photoelectric converter 13 of each pixel 10 further has a connection to a sensitivity control line 42. In the configuration illustrated in FIG. 2, the sensitivity control line 42 is connected to the voltage supply circuit 32. The voltage supply circuit 32 is an example of a first voltage supply circuit and is also called a “sensitivity control voltage supply circuit”. The voltage supply circuits 32 is a circuit configured to be able to supply at least two types of voltage. The voltage supply circuit 32 supplies a predetermined voltage to the photoelectric converter 13, or specifically, the after-mentioned counter electrode, via the sensitivity control line 42 during operation of the imaging element 110. The voltage supply circuit 32 is not limited to particular power supply circuits but may be a circuit that generates a predetermined voltage or may be a circuit that converts a voltage supplied from another power supply into a predetermined voltage. As will be described in detail later, by switching, between a plurality of voltages differing from each other, the voltage that is supplied from the voltage supply circuit 32 to the photoelectric converter 13, the start and end of storage of the signal charge from the photoelectric converter 13 into the charge storage node 41 are controlled. In other words, in the present embodiment, an electronic shutter operation is executed by switching the voltage that is supplied from the voltage supply circuit 32 to the photoelectric converter 13. An example of operation of the imaging element 110 will be described later.

The photoelectric converter 13 of each pixel 10 further has a connection to a shield line 17. In the configuration shown in FIG. 2, the shield line 17 is connected to the shield voltage supply circuit 18. The shield voltage supply circuit 18 supplies a predetermined voltage to the photoelectric converter 13, or specifically, the after-mentioned shield electrode, via the shield line 17 during operation of the imaging element 110. The shield voltage supply circuit 18 may be a circuit configured to be able to supply a plurality of voltages. The shield voltage supply circuit 18 is not limited to particular power supply circuits but may be a circuit that generates a predetermined voltage or may be a circuit that converts a voltage supplied from another power supply into a predetermined voltage. The imaging element 110 does not need to have the shield voltage supply circuit 18, and the shield voltage supply circuit 18 may be a circuit situated outside the imaging element 110. Further, the shield line 17 may be connected to the ground instead of being connected to the shield voltage supply circuit 18.

Each pixel 10 has a connection to a power wire 40 through which a power supply voltage VDD is supplied. As shown in FIG. 2, to the power wire 40, the input terminal of the signal detection transistor 24 is connected. The functioning of the power wire 40 as a source follower power supply causes the signal detection transistor 24 to amplify and output a signal corresponding to the electric charge generated by the photoelectric converter 13.

To the output terminal of the signal detection transistor 24, the input terminal of the address transistor 26 is connected. The output terminal of the address transistor 26 is connected to one of a plurality of vertical signal lines 47 placed separately for each of the rows of the pixel array PA. The control terminal of the address transistor 26 is connected to an address control line 46, and by controlling the potential of the address control line 46, output from the signal detection transistor 24 can be selectively read out to a corresponding one of the vertical signal lines 47.

In the example shown in FIG. 2, the address control line 46 is connected to the vertical scanning circuit 36. The vertical scanning circuit 36 is also called a “row scanning circuit”. The vertical scanning circuit 36 applies a predetermined voltage to the address control line 46 and thereby selects, on a row-by-row basis, a plurality of pixels 10 arranged in each row. In this way, the reading out of signals from the pixels 10 thus selected and the resetting of the charge storage nodes 41 of the pixels 10 thus selected and the after-mentioned pixel electrodes are executed.

The vertical signal lines 47 are main signal lines through which pixel signals from the pixel array PA are transmitted to the peripheral circuits. To the vertical signal lines 47, the column signal processing circuits 37 are connected. The column signal processing circuits 37 are also called “row signal storage circuits”. The column signal processing circuits 37 each perform, for example, noise suppression signal processing typified by correlated double sampling and analog-to-digital conversion (AD conversion). As shown in FIG. 2, the column signal processing circuits 37 are provided separately in correspondence with each of the rows of pixels 10 in the pixel array PA. To these column signal processing circuits 37, the horizontal signal readout circuit 38 is connected. The horizontal signal readout circuit 38 is also called a “column scanning circuit”. The horizontal signal readout circuit 38 sequentially reads out signals from the plurality of column signal processing circuits 37 to a horizontal common signal line 49.

In the configuration illustrated in FIG. 2, each of the pixels 10 has a reset transistor 28. The reset transistor 28 can be, for example, a field-effect transistor as is the case with the signal detection transistor 24 and the address transistor 26. Unless otherwise noted, the following describes an example in which an N-channel MOSFET is applied as the reset transistor 28.

As shown in FIG. 2, the reset transistor 28 is connected between a reset voltage line 44 that supplies a reset voltage Vr and the charge storage node 41. The control terminal of the reset transistor 28 is connected to a reset control line 48, and by controlling the potential of the reset control line 48, the potential of the charge storage node 41 can be reset to the reset voltage Vr. In this example, the reset control line 48 is connected to the vertical scanning circuit 36. Accordingly, the application of a predetermined voltage to the reset control line 48 by the vertical scanning circuit 36 makes it possible to reset, on a row-by-row basis, a plurality of pixels 10 arranged in each row.

In this example, the reset voltage line 44, which supplies the reset voltage Vr to the reset transistor 28, is connected to the reset voltage source 34. The reset voltage source 34 is an example of a second voltage supply circuit and is also called a “reset voltage supply circuit”. The reset voltage source 34 needs only be configured to be able to supply the predetermined reset voltage Vr to the reset voltage line 44 during operation of the imaging element 110 and, as is the case with the aforementioned voltage supply circuit 32 and shield voltage supply circuit 18, is not limited to particular power supply circuits. The voltage supply circuit 32, the shield voltage supply circuit 18, and the reset voltage source 34 may each be a portion of a single voltage supply circuit, or may each be an independent and separate voltage supply circuit. It should be noted that at least one of the voltage supply circuit 32, the shield voltage supply circuit 18, and the reset voltage source 34 may be a portion of the vertical scanning circuit 36. Alternatively, at least one of a sensitivity control voltage from the voltage supply circuit 32, a shield voltage from the shield voltage supply circuit 18, and the reset voltage Vr from the reset voltage source 34 may be supplied to each pixel 10 via the vertical scanning circuit 36.

It is also possible to use the power supply voltage VDD of the signal detection circuit 14 as the reset voltage Vr. In this case, commonality can be achieved between a voltage supply circuit (not illustrated in FIG. 2) that supplies a power supply voltage to each pixel 10 and the reset voltage source 34. Further, commonality can be achieved between the power wire 40 and the reset voltage line 44, so that wiring in the pixel array PA can be simplified. Note, however, that using different voltages as the reset voltage Vr and the power supply voltage VDD of the signal detection circuit 14 allows more flexibility in control of the imaging element 110.

### Device Structure of Pixel

Next, a cross-section structure of each of the pixels 10 of the imaging element 110 according to the present embodiment is described.

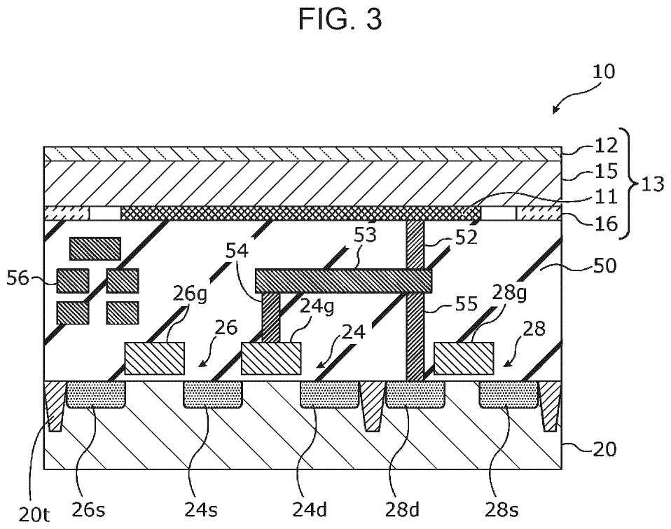

FIG. 3 is a cross-sectional view schematically showing an exemplary device structure of each of the pixels 10 according to the present embodiment. In the configuration illustrated in FIG. 3, the aforementioned signal detection transistor 24, address transistor 26, and reset transistor 28 are formed in a semiconductor substrate 20. The semiconductor substrate 20 is not limited to a substrate made entirely of a semiconductor. The semiconductor substrate 20 may be an insulating substrate having a semiconductor layer provided on a surface thereof at which a photosensitive region is formed. An example is described here in which a P-type silicon (Si) substrate is used as the semiconductor substrate 20.

The semiconductor substrate 20 has impurity regions 26s, 24s, 24d, 28d, and 28s and a device isolation region 20t that provides electrical isolation between pixels 10. The impurity regions 26s, 24s, 24d, 28d, and 28s here are N-type regions. Further, the device isolation region 20t is also provided between the impurity region 24d and the impurity region 28d. The device isolation region 20t is formed, for example, by performing ion implantation of an acceptor under predetermined implantation conditions.

The impurity regions 26s, 24s, 24d, 28d, and 28s are, for example, diffusion layers formed in the semiconductor substrate 20. As schematically shown in FIG. 3, the signal detection transistor 24 includes the impurity regions 24s and 24d and a gate electrode 24g. The impurity region 24s functions, for example, as a source region of the signal detection transistor 24. The impurity region 24d functions, for example, as a drain region of the signal detection transistor 24. The signal detection transistor 24 has its channel region formed between the impurity region 24s and the impurity region 24d.

Similarly, the address transistor 26 includes the impurity regions 26s and 24s and a gate electrode 26g connected to the address control line 46 (see FIG. 2). In this example, the signal detection transistor 24 and the address transistor 26 are electrically connected to each other by sharing the impurity region 24s. The impurity region 26s functions, for example, as a source region of the address transistor 26. The impurity region 26s has a connection to the vertical signal line 47 (see FIG. 2), which is not illustrated in FIG. 3.

The reset transistor 28 includes the impurity regions 28d and 28s and a gate electrode 28g connected to the reset control line 48 (see FIG. 2). The impurity region 28s functions, for example, as a source region of the reset transistor 28. The impurity region 28s has a connection to the reset voltage line 44 (see FIG. 2), which is not illustrated in FIG. 3. The impurity region 28d functions, for example, as a drain region of the reset transistor 28.

The gate electrodes 24g, 26g, and 28g are each made of a conducting material. The conducting material is, for example, polysilicon rendered conductive by being doped with an impurity, but may be a metal material.

An interlayer insulating layer 50 is placed over the semiconductor substrate 20 so as to cover the signal detection transistor 24, the address transistor 26, and the reset transistor 28. The interlayer insulating layer 50 is made, for example, of an insulating material such as silicon oxide. As shown in FIG. 3, a wiring layer 56 can be placed in the interlayer insulating layer 50. The wiring layer 56 is made, for example, of metal such as copper. The wiring layer 56 can include, for example, a wire such as the aforementioned vertical signal lines 47 as part thereof. The number of insulating layers in the interlayer insulating layer 50 and the number of layers included in the wiring layer 56 placed in the interlayer insulating layer 50 may be arbitrarily set and are not limited to the example shown in FIG. 3.

The aforementioned photoelectric converter 13 is placed over the interlayer insulating layer 50. In other words, in the present embodiment, the plurality of pixels 10, which constitute the pixel array PA (see FIG. 2), are formed over the semiconductor substrate 20. The plurality of pixels 10, which are arrayed two-dimensionally over the semiconductor substrate 20, form a pixel region serving as a photosensitive region. The distance between two adjacent pixels 10 can be, for example, approximately 2 μm. The distance between two adjacent pixels 10 is also called a “pixel pitch”.

The photoelectric converter 13 includes a pixel electrode 11, a counter electrode 12, and a photoelectric conversion layer 15 placed between the pixel electrode 11 and the counter electrode 12. Further, in the present embodiment, the photoelectric converter 13 further includes a shield electrode 16. The pixel electrode 11 is an example of a first electrode. The counter electrode 12 is an example of a second electrode. The shield electrode 16 is an example of a third electrode. In this example, the counter electrode 12, the photoelectric conversion layer 15, and the shield electrode 16 are formed across the plurality of pixels 10. On the other hand, the pixel electrode 11 is provided for each pixel 10 and, by being spatially isolated from the pixel electrode 11 of an adjacent pixel 10, is electrically isolated from the pixel electrode 11 of the adjacent pixel 10.

The counter electrode 12 is placed opposite the pixel electrode 11 with the photoelectric conversion layer 15 sandwiched therebetween. The counter electrode 12 is, for example, a transparent electrode made of a transparent conducting material. The counter electrode 12 is placed, for example, on a side of the photoelectric conversion layer 15 on which light falls. Accordingly, on the photoelectric conversion layer 15, light having passed through the counter electrode 12 falls. Light that is detected by the imaging element 110 is not confined to light falling within a visible light wavelength range (e.g. 380 nm to 780 nm). The term “transparent” here in means transmitting at least part of light in a wavelength range to be detected, and it is not essential to transmit light across the whole wavelength range of visible light. All electromagnetic waves including visible light, infrared radiation, and ultraviolet radiation are herein expressed as “light” for convenience. The counter electrode 12 may be made, for example, of a transparent conducting oxide (TCO) such as ITO, IZO, AZO, FTO, SnO₂, TiO₂, or ZnO₂.

The photoelectric conversion layer 15 generates a hole-electron pair as a charge pair upon receiving incident light. The photoelectric conversion layer 15 is made, for example, of an organic material. Specific examples of the material of which the photoelectric conversion layer 15 is made will be described later.

As described with reference to FIG. 2, the counter electrode 12 has a connection to the sensitivity control line 42, which is connected to the voltage supply circuit 32. Further, in this example, the counter electrode 12 is formed across the plurality of pixels 10. This enables the voltage supply circuit 32 to apply a sensitivity control voltage of desired magnitude across the plurality of pixels 10 en bloc via the sensitivity control line 42. As long as a sensitivity control voltage of desired magnitude can be applied from the voltage supply circuit 32, the counter electrode 12 may be provided separately for each of the pixels 10, or may be provided separately for each pixel block composed of two or more of the plurality of pixels 10. That is, the counter electrode 12 may be divided into a plurality of portions. Further, although, in the example shown in FIG. 2, the sensitivity control line 42 connected to the counter electrode 12 is connected to one voltage supply circuit 32, this is not intended to impose any limitation. In a case where the counter electrode 12 is divided into a plurality of portions, each of the plurality of portion of the counter electrode 12 may be connected via the sensitivity control line 42 to a corresponding one of a plurality of the voltage supply circuits 32.

Similarly, the photoelectric conversion layer 15 may be provided separately for each of the pixels 10, or may be provided separately for each pixel block composed of two or more of the plurality of pixels 10. That is, the photoelectric conversion layer 15 may be divided into a plurality of portions.

The voltage supply circuit 32 applies a voltage between the pixel electrode 11 and the counter electrode 12 by supplying a voltage to the counter electrode 12. As will be described in detail later, for example, the voltage supply circuit 32 supplies, to the counter electrode 12, voltages differing from one another between an exposure period and a non-exposure period. The term “exposure period” herein means a period during which to store, in the charge storage region, signal charge that is either positive or negative charge generated by photoelectric conversion, and may be called a “charge storage period”.

Further, the term “non-exposure period” means a period during operation of the imaging device excluding the exposure period. It should be noted that the “non-exposure period” is not limited to a period during which light is blocked from falling on the photoelectric converter 13, but may include a period during which the photoelectric converter 13 is illuminated with light. Further, the “non-exposure period” includes a period during which signal charge is unintentionally stored in the charge storage region due to the occurrence of parasitic sensitivity.

By controlling the potential of the counter electrode 12 in relation to the potential of the pixel electrode 11, i.e. the voltage that is applied between the pixel electrode 11 and the counter electrode 12, either the hole or electron of a hole-electron pair generated in the photoelectric conversion layer 15 by photoelectric conversion can be collected by the pixel electrode 11. The voltage that is applied between the pixel electrode 11 and the counter electrode 12 is also referred to as a “bias voltage”. The signal charge collected by the pixel electrode 11 is stored in the charge storage region. For example, in a case where the hole is utilized as the signal charge, the hole can be selectively collected by the pixel electrode 11 by making the counter electrode 12 higher in potential than the pixel electrode 11. Alternatively, for example, in a case where the electron is utilized as the signal charge, the electron can be selectively collected by the pixel electrode 11 by making the counter electrode 12 lower in potential than the pixel electrode 11. The following illustrates a case where the hole is utilized as the signal charge. As a matter of course, it is also possible to utilize the electron as the signal charge.

The counter electrode 12 is, for example, connected to the aforementioned sensitivity control line 42 in a region around the pixel array PA and supplied with a voltage from the voltage supply circuit 32. It should be noted that the counter electrode 12 may be supplied with a voltage from the voltage supply circuit 32 via a via contact bored through the photoelectric conversion layer 15 and via the wiring layer 56.

In the presence of the application of an appropriate bias voltage between the counter electrode 12 and the pixel electrode 11 as mentioned above, the pixel electrode 11, which faces the counter electrode 12, collects either positive or negative charge generated by photoelectric conversion in the photoelectric conversion layer 15. The pixel electrode 11 is made, for example, of metal such as aluminum or copper, a metal nitride, polysilicon rendered conductive by being doped with an impurity, or other materials.

The pixel electrode 11 may be a light-blocking electrode. For example, a sufficient light blocking effect can be achieved by forming, as the pixel electrode 11, a TaN electrode whose thickness is 100 nm. When the pixel electrode 11 is a light-blocking electrode, light having passed through the photoelectric conversion layer 15 can be inhibited from falling on the channel region or impurity regions of a transistor formed in the semiconductor substrate 20, or in this example, at least any of the signal detection transistor 24, the address transistor 26, and the reset transistor 28. The aforementioned wiring layer 56 may be utilized to form a light-blocking film in the interlayer insulating layer 50. By inhibiting light from falling on the channel region of a transistor formed in the semiconductor substrate 20, a shift in the characteristic of the transistor, such as a fluctuation in threshold voltage, or other changes can be inhibited. Further, by inhibiting light from falling on an impurity region formed in the semiconductor substrate 20, noise contamination by unintended photoelectric conversion in the impurity region can be inhibited. Thus, inhibiting light from falling on the semiconductor substrate 20 contributes to improvement in reliability of the imaging element 110.

As schematically shown in FIG. 3, the pixel electrode 11 is connected to the gate electrode 24g of the signal detection transistor 24 via the plug 52, a wire 53, and a contact plug 54. In other words, the gate of the signal detection transistor 24 has an electrical connection to the pixel electrode 11. The plug 52 and the wire 53 are made, for example, of metal such as copper. The plug 52, the wire 53, and the contact plug 54 constitute at least part of the charge storage node 41 (see FIG. 2) between the signal detection transistor 24 and the photoelectric converter 13. The wire 53 can be part of the wiring layer 56. Further, the pixel electrode 11 is also connected to the impurity region 28d via the plug 52, the wire 53, and a contact plug 55. In the configuration illustrated in FIG. 2, the gate electrode 24g of the signal detection transistor 24, the plug 52, the wire 53, the contact plugs 54 and 55, and the impurity region 28d, which is one of the source region and the drain region of the reset transistor 28, function as a charge storage region in which to store signal charge collected by the pixel electrode 11.

The collection of signal charge by the pixel electrode 11 causes a voltage corresponding to the quantity of signal charge stored in the charge storage region to be applied to the gate of the signal detection transistor 24. The voltage that is applied to the gate of the signal detection transistor 24 corresponds to the potential of the charge storage node 41. The signal detection transistor 24 amplifies this voltage. The voltage amplified by the signal detection transistor 24 is selectively read out as a signal voltage via the address transistor 26.

The shield electrode 16 is placed opposite the counter electrode 12 behind the photoelectric conversion layer 15. Further, although not shown in FIG. 3, as mentioned above, the shield electrode 16 has a connection to the shield line 17, and a voltage is applied from the shield voltage supply circuit 18 via the shield line 17. Part of the shield line 17 can be included in the wiring layer 56. Although not illustrated in FIG. 3, the shield electrode 16 may be connected to the wiring layer 56 via a contact or other components.

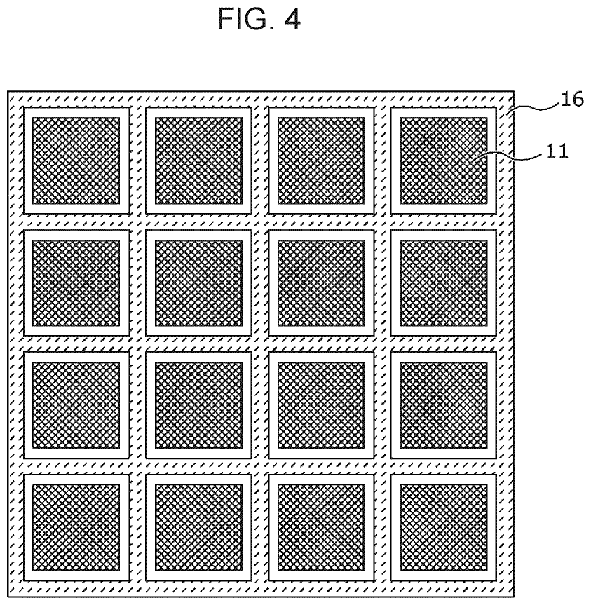

The shield electrode 16 and the pixel electrode 11 are placed, for example, at the same level in the interlayer insulating layer 50 and separated from each other by part of the interlayer insulating layer 50. FIG. 4 is a plan view showing an example of a planar layout of pixel electrodes 11 and the shield electrode 16. It should be noted that FIG. 4 omits to illustrate components other than the pixel electrodes 11 and the shield electrode 16. Further, for ease of viewability, FIG. 4 shades the pixel electrodes 11 and the shield electrode 16 in the same manners as the pixel electrode 11 and the shield electrode 16 shown in a cross-section of FIG. 3.

As shown in FIG. 4, the pixel electrode 11 are arranged, for example, in an array. The shield electrode 16 is placed between adjacent ones of the pixel electrodes 11 in a plan view. In the illustrated example, the shield electrode 16 surrounds each of the pixel electrodes 11 in the plan view. Specifically, the shield electrode 16 is placed in a grid pattern of straight lines that cross each other and form squares in the plan view, and the pixel electrodes 11 are placed separately in each of the squares. As mentioned above, the shield electrode 16 is formed, for example, as a single unit across the plurality of pixels 10 and is unipotential throughout all pixels 10.

The shield electrode 16 may be provided separately for each of the pixels 10, or may be provided separately for each pixel block composed of two or more of the plurality of pixels 10. That is, the shield electrode 16 may be divided into a plurality of portions. Further, although, in the example shown in FIG. 2, the shield line 17, which is connected to the shield electrode 16, is connected to one shield voltage supply circuit 18, this is not intended to impose any limitation. In a case where the shield electrode 16 is divided into a plurality of portions, each of the plurality of portion of the shield electrode 16 may be connected via a shield line 17 to a corresponding one of a plurality of the shield voltage supply circuits 18.

The voltage that is applied to the shield electrode 16 can be utilized to inhibit migration of signal charge between pixels 10, i.e. crosstalk. This makes it possible to inhibit mixture of colors without physically separating the photoelectric conversion layer 15. The voltage that is applied to the shield electrode 16 can be set, for example, so that the potential of the shield electrode 16 becomes higher than the potential of the pixel electrode 11. For example, a voltage that is higher than the reset voltage Vr is applied to the shield electrode 16. This makes it easier for a hole to migrate to the pixel electrode 11 surrounded by the shield electrode 16 in the plan view and makes it possible to inhibit a hole from migrating to an adjacent pixel 10 over the shield electrode 16. Alternatively, the voltage that is applied to the shield electrode 16 can be set so that the potential of the shield electrode 16 becomes lower than the potential of the pixel electrode 11. For example, a voltage that is lower than the reset voltage Vr is applied to the shield electrode 16. This causes a hole migrating to the pixel electrode 11 of an adjacent pixel 10 over the shield electrode 16 in the plan view to be trapped by the shield electrode 16 and makes it possible to inhibit the hole from migrating to the pixel electrode 11 of the adjacent pixel 10 over the shield electrode 16.

The shield electrode 16 is made, for example, of metal such as aluminum or copper, a metal nitride, polysilicon rendered conductive by being doped with an impurity, or other materials. The shield electrode 16 may be a light-blocking electrode. Further, the shield electrode 16 may be made of the same material as the pixel electrode 11. Further, the shield electrode 16 and the pixel electrode 11 may be formed at the same time in the same process.

It should be noted that at least one of each circuit of the peripheral circuits of the aforementioned imaging element 110, the current change detection circuit 130, and the drive control circuit 140 may be formed in the same semiconductor substrate 20 as the imaging element 110.

### Example of Configuration of Photoelectric Conversion Layer

Next, the photoelectric conversion layer 15 is described in detail.

As mentioned above, by illuminating the photoelectric conversion layer 15 with light and applying a bias voltage between the pixel electrode 11 and the counter electrode 12, either positive or negative charge generated by photoelectric conversion is collected by the pixel electrode 11, and the electric charge thus collected can be stored in the charge storage region. By using a photoelectric converter 13 having a photoelectric conversion layer 15 that exhibits a photocurrent characteristic such as that described below and reducing the potential difference between the pixel electrode 11 and the counter electrode 12 to a certain degree, the signal charge already stored in the charge storage region can be inhibited from migrating to the counter electrode 12 via the photoelectric conversion layer 15. Furthermore, further storage of signal charge into the charge storage region after the reduction of the potential difference can be inhibited. That is, by controlling the magnitude of a bias voltage that is applied to the photoelectric converter 13, a global shutter function can be achieved without separately providing each of the plurality of pixels 10 with an element such as a transfer transistor as in the case of a technology described in Japanese Patent No. 6799784. An example of operation in the imaging device 100 will be described later. Further, as a matter of course, normal rolling shutter driving is enabled by holding constant the magnitude of a bias voltage that is applied to the photoelectric converter 13 and starting the exposure period upon completion of resetting of the pixel 10.

The following describes an example of a configuration of the photoelectric conversion layer 15.

The photoelectric conversion layer 15 contains, for example, a semiconductor material. In the present embodiment, for example, an organic semiconductor material is used as the semiconductor material.

The photoelectric conversion layer 15 contains, for example, tin naphthalocyanine represented by general formula (1) below. In the following, the tin naphthalocyanine represented by general formula (1) below is sometimes simply called “tin naphthalocyanine”.

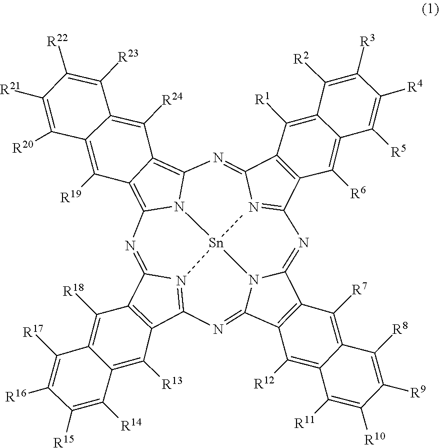

In general formula (1), R¹ to R²⁴ each independently represent a hydrogen atom or a substituent. The substituent is not limited to particular substituents. The substituent can be a deuterium atom, a halogen atom, an alkyl group (including a cycloalkyl group, a bicycloalkyl group, and a tricycloalkyl group), an alkenyl group (including a cycloalkenyl group and a bicycloalkenyl group), an alkynyl group, an aryl group, a heterocyclic group, a cyano group, a hydroxy group, a nitro group, a carboxy group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an ammonio group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, an alkoxycarbonyl group, a carbamoyl group, an arylazo group, a heterocyclic azo group, an imide group, a phosphino group, a phosphinyl group, a phosphinyloxy group, a phosphinylamino group, a phosphono group, a silyl group, a hydrazino group, a ureide group, a boronic acid group (—B(OH)₂), a phosphato group (—OPO(OH)₂), a sulfato group (—OSO₃H), or other publicly-known substituents.

As the tin naphthalocyanine represented by general formula (1) above, a commercially available product may be used. Alternatively, for example, as disclosed in Japanese Unexamined Patent Application Publication No. 2010-232410, the tin naphthalocyanine represented by general formula (1) above may be synthesized with a naphthalene derivative represented by general formula (2) below as a starting material. R²⁵ to R³⁰ in general formula (2) can be substituents that are similar to R¹ to R²⁴ in general formula (1).

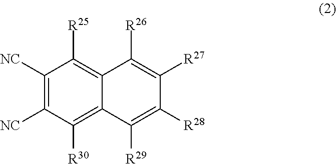

In the tin naphthalocyanine represented by general formula (1) above, eight or more of R¹ to R²⁴ may be hydrogen atoms or deuterium atoms, sixteen of more of R¹ to R²⁴ may be hydrogen atoms or deuterium atoms, or all of R¹ to R²⁴ may be hydrogen atoms or deuterium atoms from the point of view of ease of control of a molecular aggregation state. Furthermore, tin naphthalocyanine represented by general formula (3) below is advantageous in view of ease of synthesis.

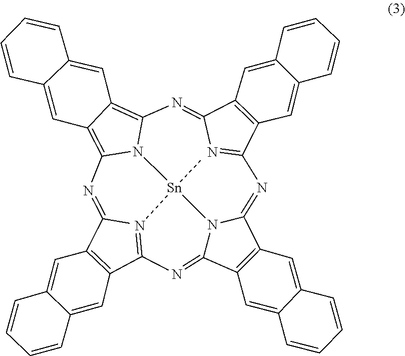

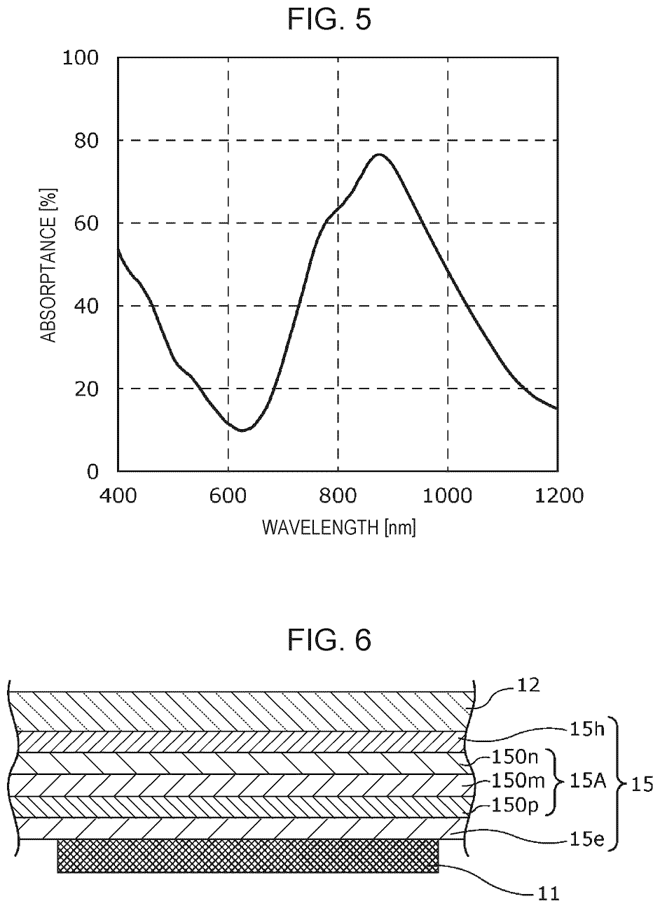

The tin naphthalocyanine represented by general formula (1) above has absorption in a wavelength range of approximately 200 nm to 1100 nm. The tin naphthalocyanine represented by general formula (3) above has an absorption peak at a wavelength of approximately 870 nm as shown in FIG. 5. FIG. 5 is a diagram showing an example of an absorbing spectrum in a photoelectric conversion layer containing the tin naphthalocyanine represented by general formula (3) above. It should be noted that the measurement of the absorption spectrum involves the use of a sample having a 30-nanometer-thick photoelectric conversion layer stacked over a quartz substrate.

As can be seen from FIG. 5, a photoelectric conversion layer made of a material containing tin naphthalocyanine has absorption in the visible light wavelength region and the near-infrared wavelength region. By selecting a material containing tin naphthalocyanine as a material of which the photoelectric conversion layer 15 is made, an optical sensor capable of detecting near infrared radiation can be achieved, for example. Further, instead of tin naphthalocyanine, a naphthalocyanine derivative whose central metal is not tin but silicon or another metal such as germanium may be used. Further, axial ligands may coordinate to the central metal of the naphthalocyanine derivative.

FIG. 6 is a cross-sectional view schematically showing an example of a configuration of the photoelectric conversion layer 15. In the configuration illustrated in FIG. 6, the photoelectric conversion layer 15 has, for example, a hole blocking layer 15h, a photoelectric conversion structure 15A, and an electron blocking layer 15e. The hole blocking layer 15h is placed between the photoelectric conversion structure 15A and the counter electrode 12, and the electron blocking layer 15e is placed between the photoelectric conversion structure 15A and the pixel electrode 11. It should be noted that the photoelectric conversion layer 15 does not need to have at least one of the hole blocking layer 15h and the electron blocking layer 15e.

The photoelectric conversion structure 15A shown in FIG. 6 contains, for example, at least one of a p-type semiconductor and an n-type semiconductor. In the configuration illustrated in FIG. 6, the photoelectric conversion structure 15A has a p-type semiconductor layer 150p, an n-type semiconductor layer 150n, and a mixed layer 150m sandwiched between the p-type semiconductor layer 150p and the n-type semiconductor layer 150n. The p-type semiconductor layer 150p is placed between the electron blocking layer 15e and the mixed layer 150m and has a photoelectric conversion and/or hole transport function. The n-type semiconductor layer 150n is placed between the hole blocking layer 15h and the mixed layer 150m and has a photoelectric conversion and/or electron transport function. As will be described later, the mixed layer 150m may contain at least one of a p-type semiconductor and an n-type semiconductor.

The p-type semiconductor layer 150p contains an organic p-type semiconductor, and the n-type semiconductor layer 150n contains an organic n-type semiconductor. Therefore, the photoelectric conversion structure 15A contains an organic photoelectric conversion material containing the tin naphthalocyanine represented by general formula (1) above, the organic p-type semiconductor, and the organic n-type semiconductor.

The organic p-type semiconductor is a donor organic semiconductor and, typified mainly by a hole transport organic compound, refers to an electron-donating organic compound. In more particular, the organic p-type semiconductor is a donor organic compound and refers to an organic compound that is lower in ionization potential when two organic materials are used in contact with each other. Accordingly, it is possible to use any electron-donating organic compound as the donor organic compound. Usable examples of the donor organic compound include metal complexes having, as ligands, a triarylamine compound, a benzidine compound, a pyrazoline compound, a styrylamine compound, a hydrazone compound, a triphenylmethane compound, a carbazole compound, a polysilane compound, a thiophene compound, a phthalocyanine compound, naphthalocyanine compound, a subphthalocyanine compound, a cyanine compound, a merocyanine compound, an oxonol compound, a polyamine compound, an indole compound, a pyrrole compound, a pyrazole compound, a polyarylene compound, a condensed aromatic carbocyclic compound (naphthalene derivative, anthracene derivative, phenanthrene derivative, tetracene derivative, pyrene derivative, perylene derivative, fluoranthene derivative), and a nitrogen-containing heterocyclic compound. The donor organic semiconductor is not limited to this, and an organic material that is lower in ionization potential than an organic material used as the after-mentioned acceptor organic compound can be used as the donor organic semiconductor. The aforementioned “tin naphthalocyanine” is an example of an organic p-type semiconductor material.

The organic n-type semiconductor is an acceptor organic semiconductor and, typified mainly by an electron transport organic compound, refers to an electron-accepting organic compound. In more particular, the organic n-type semiconductor is an acceptor organic compound and refers to an organic compound that is higher in ionization potential when two organic compounds are used in contact with each other. Accordingly, it is possible to use any electron-accepting organic compound as the acceptor organic compound. Usable examples of the acceptor organic compound include metal complexes having, as ligands, a fullerene, a fullerene derivative, a condensed aromatic carbocyclic compound (naphthalene derivative, anthracene derivative, phenanthrene derivative, tetracene derivative, pyrene derivative, perylene derivative, fluoranthene derivative), a 5- to 7-membered heterocyclic compound containing a nitrogen atom, an oxygen atom, or a sulfur atom (such as pyridine, pyrazine, pyrimidine, pyridazine, triazine, quinoline, quinoxaline, quinazoline, phthalazine, cinnoline, isoquinoline, pteridine, acridine, phenazine, phenanthroline, tetrazole, pyrazole, imidazole, thiazole, oxazole, indazole, benzimidazole, benzotriazole, benzoxazole, benzothiazole, carbazole, purine, triazolopyridazine, triazolopyrimidine, tetrazaindene, oxadiazole, imidazopyridine, pyrrolidine, pyrrolopyridine, thiadiazolopyridine, dibenzazepine, or tribenzazepine), a polyarylene compound, a fluorene compound, a cyclopentadiene compound, a silyl compound, and a nitrogen-containing heterocyclic compound. The acceptor organic semiconductor is not limited to this, and as mentioned above, an organic material that is higher in electron affinity than an organic material used as the donor organic compound can be used as the acceptor organic semiconductor.

The mixed layer 150m can be, for example, a bulk heterojunction structure layer including an organic p-type semiconductor and an organic n-type semiconductor. In a case where the mixed layer 150m is formed as a layer having a bulk heterojunction structure, the tin naphthalocyanine represented by general formula (1) above can be used as the organic p-type semiconductor material. As the organic n-type semiconductor material, for example, a fullerene and/or a fullerene derivative can be used.

From the point of view of improving photoelectric conversion efficiency, the material constituting the p-type semiconductor layer 150p may be the same as the p-type semiconductor material contained in the mixed layer 150m. Similarly, the material constituting the n-type semiconductor layer 150n may be the same as the n-type semiconductor material contained in the mixed layer 150m. A bulk heterojunction structure is described in detail in Japanese Patent No. 5553727, the entire contents of which are hereby incorporated by reference.

Using appropriate materials depending on the wavelength range to be detected makes it possible to achieve an imaging element 110 having sensitivity to the desired wavelength range. The photoelectric conversion layer 15 may contain an inorganic semiconductor material such as amorphous silicon or a compound semiconductor. The photoelectric conversion layer 15 may include a layer made of an organic material and a layer made of an inorganic material. The following illustrates an example in which a bulk heterojunction structure obtained by co-evaporation of tin naphthalocyanine and the C60 fullerene is applied to the photoelectric conversion layer 15.

While the foregoing has described a photoelectric conversion layer 15 containing tin naphthalocyanine and having sensitivity to near infrared radiation, the material contained in the photoelectric conversion layer 15 is not limited to a photoelectric conversion material having sensitivity to near infrared radiation. For example, by containing subphthalocyanine as the p-type semiconductor and containing a fullerene and/or a fullerene derivative as the n-type semiconductor, the photoelectric conversion layer 15 can be a photoelectric conversion layer 15 having sensitivity to visible light.

### Photocurrent Characteristics of Photoelectric Converter

Next, the photocurrent characteristics of the photoelectric converter 13 are described.

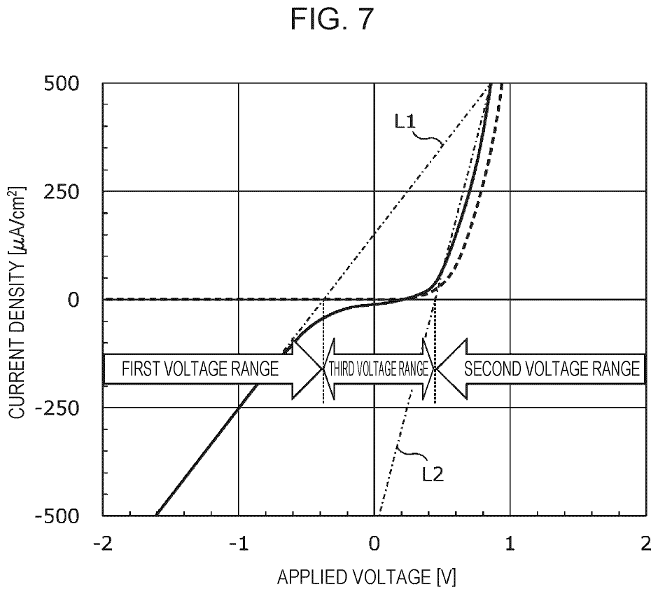

FIG. 7 is a diagram showing an exemplary photocurrent characteristic of the photoelectric converter 13. In the graph of FIG. 7, the solid line indicates an exemplary current-voltage characteristic (I-V characteristic) of the photoelectric converter 13 in a state of being illuminated with light, i.e. a bright time. In FIG. 7, the dotted line indicates an example of an I-V characteristic of the photoelectric converter 13 in a state of not being illuminated with light, i.e. a dark time.

FIG. 7 shows a change in the density of an electric current that, under constant illuminance, flows between principal surfaces of the photoelectric conversion layer 15 when a bias voltage that is applied between the pixel electrode 11 and the counter electrode 12 of the photoelectric converter 13 is changed. In a case where the photoelectric conversion layer 15 has a junction structure of a layered p-type semiconductor and a layered n-type semiconductor, a bias voltage that makes a layer of the p-type semiconductor layer higher in potential than a layer of the n-type semiconductor layer is defined as a forward bias voltage. On the other hand, a bias voltage that makes the layer of the p-type semiconductor layer lower in potential than the layer of the n-type semiconductor layer is defined as a backward bias voltage. In a case where the photoelectric conversion layer 15 has a bulk heterojunction structure, as schematically shown in FIG. 1 of the aforementioned Japanese Patent No. 5553727, more of the p-type semiconductor than the n-type semiconductor appears in one of two principal surfaces of the bulk heterojunction structure that faces an electrode, and more of the n-type semiconductor than the p-type semiconductor appears in the other principal surface. Accordingly, a bias voltage that makes the potential on the principal surface in which more of the p-type semiconductor than the n-type semiconductor appears higher than the potential on the principal surface in which more of the n-type semiconductor than the p-type semiconductor appears is defined as a forward bias voltage. In the present embodiment, for example, a voltage that makes the potential of the counter electrode 12 higher than the potential of the pixel electrode 11 is a backward bias voltage, and a voltage that makes the potential of the counter electrode 12 lower than the potential of the pixel electrode 11 is a forward bias voltage.

As shown in FIG. 7, the photocurrent characteristic of the photoelectric converter 13 is schematically characterized by three voltage ranges, namely first to third voltage ranges. The first voltage range is a range of backward bias voltages, and is a voltage range in which the absolute value of an output current density increases with an increase in backward bias voltage. The first voltage range may also be said to be a voltage range in which a photoelectric current increases with an increase in a bias voltage that is applied between the pixel electrode 11 and the counter electrode 12. The second voltage range is a range of forward bias voltages, and is a voltage range in which the output current density increases with an increase in forward bias voltage. That is, the second voltage range is a voltage range in which a photocurrent that is opposite in direction to the first voltage range increases with an increase in a bias voltage that is applied between the pixel electrode 11 and the counter electrode 12. The third voltage range is a voltage range between the first voltage range and the second voltage range.

The first to third voltage ranges may be distinguished from one another by the slopes of lines of the graph of the photocurrent characteristic when linear vertical and horizontal axes are used. For reference, in FIG. 7, the average slopes of lines of the graph in the first voltage range and the second voltage range are indicated by a dot-and-dash line L1 and a dot-and-dash line L2, respectively. As illustrated in FIG. 7, the rates of change in output current density in response to increases in bias voltage in the first voltage range, the second voltage range, and the third voltage range are different from one another. Further, the third voltage range is defined as a voltage range in which the rate of change in output current density voltage in response to an increase in bias voltage is lower than the rates of change in output current density in response to increases in bias voltage in the first voltage range and the second voltage range. Alternatively, the third voltage range may be determined on the basis of the position of a rising edge (falling edge) in the graph of the I-V characteristic. The third voltage range is for example larger than −1 V and smaller than +1 V. In the third voltage range, a change in bias voltage causes almost no change in current density between the principal surfaces of the photoelectric conversion layer 15. As illustrated in FIG. 7, in the third voltage range, the absolute value of the current density is for example less than or equal to 100 μA/cm².

Further, in the case of comparisons made under the same illuminance conditions, the difference between a dark-time current and a bright-time current in the third voltage range is smaller than the difference between a dark-time current and a bright-time current in the first voltage range and the difference between a dark-time current and a bright-time current in the second voltage range. The term “dark-time current” here means an electric current that flows through the photoelectric conversion layer 15 in a state of not being illuminated with light, and the term “bright-time current” here means an electric current that flows through the photoelectric conversion layer 15 in a state of being illuminated with light.

The I-V characteristic of the photoelectric converter 13 shown in FIG. 7 is merely an example, and an intended I-V characteristic can be attained by adjusting the configuration and material of the photoelectric conversion layer 15 described above. Operation of Normal Imaging by Imaging Device

Next, as an operation of the imaging device 100, an operation in which a normal image is taken is described. Driving of the imaging device 100 in a mode of taking a normal image as explained below is herein referred to as “normal imaging driving”.

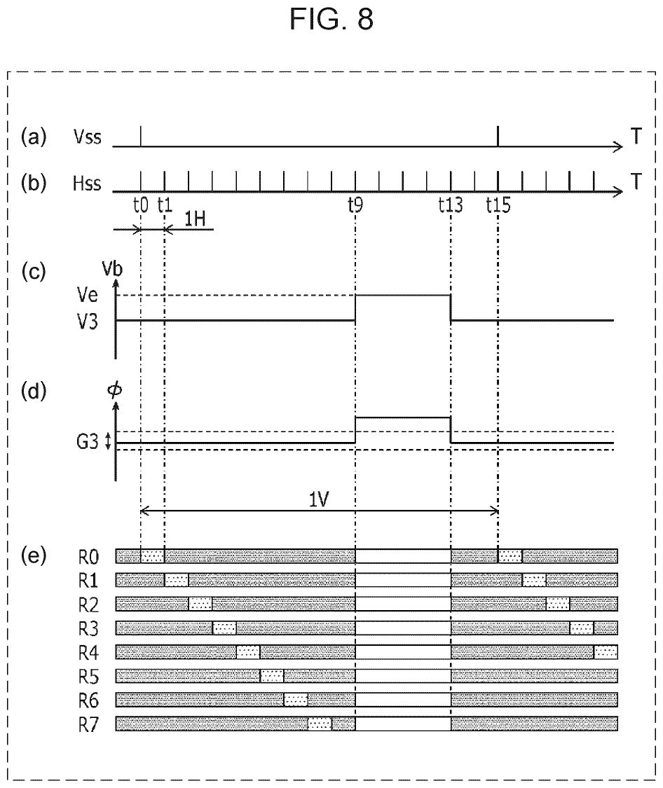

FIG. 8 is a diagram for explaining an example of an operation of normal imaging driving in the imaging device 100 according to the present embodiment. FIG. 8 shows the timing of falling edges or rising edges of synchronization signals, temporal changes in the magnitude of a bias voltage that is applied to the photoelectric converter 13, and the timing of resets and exposures in each row of the pixel array PA (see FIG. 2) together.

More specifically, graph (a), at the top of FIG. 8, shows the timing of falling edges or rising edges of a vertical synchronization signal Vss. Graph (b) of FIG. 8 shows the timing of falling edges or rising edges of a horizontal synchronization signal Hss. Graph (c) of FIG. 8 shows an example of a temporal change in a voltage Vb that is applied from the voltage supply circuit 32 to the counter electrode 12 via the sensitivity control line 42. Graph (d) of FIG. 8 shows a temporal change in a potential φ (i.e. a bias voltage) of the counter electrode 12 with reference to the potential of the pixel electrode 11. The double-headed arrow G3 in the graph (d) of the potential φ of FIG. 8 indicates the aforementioned third voltage range. Further, in this example, the first voltage range is above the double-headed arrow G3, and the second voltage range is below the double-headed arrow G3. Chart (e) of FIG. 8 schematically shows the timing of resets and exposures in each row of the pixel array PA.

The following describes an example of the operation of normal imaging driving in the imaging device 100 with reference to FIGS. 2, 3, and 8. For simplicity, the following describes an example of operation in which the pixel array PA includes a total of eight rows of pixels 10, namely the R0th to R7th rows. It should be noted that the order of pixel rows shown in chart (e) of FIG. 8 does not need to coincide with the actual order of pixel rows, and the actual arrangement of pixels is not limited in particular.

In the acquisition of an image, first, the resetting of the charge storage region of each pixel 10 in the pixel array PA and the reading out of a post-reset pixel signal are executed. For example, as shown in FIG. 8, the resetting of a plurality of pixels 10 belonging to the R0th row is started in accordance with the vertical synchronization signal Vss (time t0). It should be noted that the low-density halftone dotted rectangles in chart (e) of FIG. 8 schematically represent signal readout periods. These readout periods can include, as part thereof, reset periods in which to reset the potentials of the charge storage regions of the pixels 10.

In the resetting of a pixel 10 belonging to the R0th row, the address transistor 26, whose gate is connected to the address control line 46 of the R0th row, is turned on by controlling the potential of the address control line 46, and the reset transistor 28, whose gate is connected to the reset control line 48 of the R0th row, is turned on by controlling the potential of the reset control line 48. As a result of this, the charge storage node 41 and the reset voltage line 44 become connected to each other, and the reset voltage Vr is supplied to the charge storage region. That is, the potentials of the charge storage node 41, the gate electrode 24g of the signal detection transistor 24, and the pixel electrode 11 of the photoelectric converter 13 are reset to the reset voltage Vr. After that, a pixel signal corresponding to the potential of the charge storage region after the resetting is read out from the pixel 10 of the R0th row via the vertical signal line 47. The pixel signal thus obtained is a pixel signal corresponding to the magnitude of the reset voltage Vr. After the reading out of the pixel signal, the reset transistor 28 and the address transistor 26 are turned off. In a case where a pixel signal corresponding to the quantity of electric charge stored in the charge storage region of the pixel 10 in the preceding frame is read out, the reading out of a pixel signal may also be performed prior to the resetting.

In this example, as schematically shown in FIG. 8, the resetting of pixels 10 belonging separately to each of the R0th to R7th rows are executed in sequence on a row-by-row basis in synchronization with the horizontal synchronization signal Hss. In the following, a pulse interval of the horizontal synchronization signal Hss, i.e., a period from selection of one row to selection of the next row, is sometimes called a “1H period”. In this example, the 1H period is equivalent to the period from time to to time t1.

As shown in FIG. 8, during the period from the start of image acquisition to the end of the resetting of all rows of the pixel array PA and the reading out of pixel signals (from time t0 to time t9), such a voltage V3 is applied from the voltage supply circuit 32 to the counter electrode 12 that the voltage that is applied between the pixel electrode 11 and the counter electrode 12 falls within the aforementioned third voltage range. That is, during the period from the start of image acquisition to the start (time t9) of the exposure period, a bias voltage in the third voltage range is applied between the pixel electrode 11 and the counter electrode 12.

In the presence of the application of a bias voltage in the third voltage range between the pixel electrode 11 and the counter electrode 12, the migration of signal charge from the photoelectric conversion layer 15 to the charge storage region hardly occurs. A reason for this is that in the presence of the application of a bias voltage in the third voltage range between the pixel electrode 11 and the counter electrode 12, most positive and negative charges generated by illumination with light rapidly recombine to disappear before being collected by the pixel electrode 11. Accordingly, in the presence of the application of a bias voltage in the third voltage range between the pixel electrode 11 and the counter electrode 12, the storage of electric charge into the charge storage region hardly occurs even when light falls on the photoelectric conversion layer 15. This reduces the occurrence of unintended sensitivity in a period other than the exposure period. Such unintended sensitivity is also called “parasitic sensitivity”.

With attention focused on a certain row (e.g. the R0th row) in chart (e) of FIG. 8, the periods indicated by the low-density halftone dotted rectangles and the high-density halftone dotted rectangles represent the non-exposure period. In the example shown in FIG. 8, a bias voltage in the third voltage range is applied between the pixel electrode 11 and the counter electrode 12 during the non-exposure period. It should be noted that the voltage V3, which causes a bias voltage in the third voltage range to be applied between the pixel electrode 11 and the counter electrode 12, is not limited to 0 V. The voltage V3 is set according to the reset voltage Vr so that the bias voltage falls within the third voltage range.

Next, after the end of the resetting of all rows of the pixel array PA and the reading out of pixel signals, the exposure period is started in accordance with the horizontal synchronization signal Hss (time t9). In chart (e) of FIG. 8, the white rectangles schematically represent the exposure period separately in each row. The exposure period is started by the voltage supply circuit 32 switching to applying the voltage Ve, which is different from the voltage V3, to the counter electrode 12. The voltage Ve is, for example, such a voltage, e.g. approximately 10 V, that the bias voltage that is applied between the pixel electrode 11 and the counter electrode 12 falls within the aforementioned first voltage range. By the voltage Ve being applied to the counter electrode 12, signal charge, in this example, a hole, in the photoelectric conversion layer 15 is collected by the pixel electrode 11 and stored in the charge storage region including the charge storage node 41. The voltage Ve is set, for example, according to the reset voltage Vr so that the bias voltage falls within the first voltage range.

Next, the voltage supply circuit 32 switches again to applying the voltage V3 to the counter electrode 12, whereby the exposure period ends (time t13). Thus, in the imaging device 100, switching between applying the voltage V3 to the counter electrode 12 and applying the voltage Ve to the counter electrode 12 enables switching between the exposure period and the non-exposure period. As can be seen from FIG. 8, the start (time t9) and end (time t13) of the exposure period in this example are common to all pixels 10 included in the pixel array PA. That is, the operation described here is an example in which the global shutter method is applied to the imaging device 100, and the imaging device 100 is driven by the global shutter method, in which the exposure period is defined by changing a voltage that the voltage supply circuit 32 applies between the pixel electrode 11 and the counter electrode 12.

Next, the reading out of pixel signals from pixels 10 belonging separately to each row of the pixel array PA is performed in accordance with the horizontal synchronization signal Hss. In this example, the reading out of signal charge from pixels 10 belonging separately to each of the R0th to R7th rows are executed in sequence on a row-by-row basis from time t15. In the following, the period from selection of a pixel 10 belonging to one row to reselection of a pixel 10 belonging to the row is sometimes called a “1V period”. In this example, the 1V period is equivalent to the period from time to to time t15. The 1V period is, for example, a one-frame period.

In the reading out, which starts at time t15, of a pixel signal from a pixel 10 belonging to the R0th row after the end of the exposure period, first the address transistor 26 of the R0th row is turned on. This causes a pixel signal corresponding to the quantity of electric charge stored in the charge storage region during the exposure period, i.e. the potential of the charge storage region after the exposure period, to be outputted to the vertical signal line 47. The reading out of the pixel signal may be followed by the turning on of the reset transistor 28 to perform the resetting of the pixel 10. Further, if necessary, this resetting may be followed by the reading out of the pixel signal. The reading out of the pixel signal is followed by the turning off of the address transistor 26 and, in a case where the resetting of the pixel 10 has been performed, also followed by the turning off of the reset transistor 28.

After the reading out of pixel signals from pixels 10 belonging separately to each row of the pixel array PA, signals from which stationary noise has been eliminated are obtained by taking the differences between the pixel signals and post-reset pixel signals read out during the period between time t0 and time t9. This elimination of stationary noise is performed, for example, by the column signal processing circuits 37. Further, the elimination of stationary noise may be performed before AD conversion of the pixel signals or may be performed after AD conversion of the pixel signals. Signals are read out by the horizontal signal readout circuit 38 from the column signal processing circuits 37, subjected to signal processing, for example, by a signal processing circuit (not illustrated) or other circuits as needed, and outputted to a device external to the imaging device 100. In a case where resets are performed after the reading out of pixel signals after the exposure periods, signals from which stationary noise has been eliminated may be obtained by taking the differences between readouts of pixel signals after the resets and readouts of pixel signals before the resets.

In the non-exposure period, during which the voltage V3 is applied to the counter electrode 12, a bias voltage in the third voltage range is applied to the photoelectric converter 13. Therefore, the further storage of signal charge into the charge storage region hardly occurs even when light falls on the photoelectric conversion layer 15. This inhibits the generation of noise attributed to unintended contamination with electric charge.

In this example, since switching to applying the voltage V3 to the counter electrode 12 is done again after the end of the exposure period, a bias voltage in the third voltage range is applied to the photoelectric converter 13 after the storage of signal charge into the charge storage region. In the presence of the application of a bias voltage in the third voltage range, it is possible to inhibit signal charge already stored in the charge storage region from migrating to the counter electrode 12 via the photoelectric conversion layer 15. In other words, the application of a bias voltage in the third voltage range to the photoelectric converter 13 makes it possible to retain, in the charge storage region, signal charge stored during the exposure period. This makes it possible to reduce the occurrence of negative parasitic sensitivity due to a loss of signal charge from the charge storage region.

Thus, in the present embodiment, the start and end of the exposure period are controlled by the voltage Vb, which is applied to the counter electrode 12. That is, the present embodiment makes it possible to achieve a global shutter function without providing a transfer transistor or other components in each pixel 10. The present embodiment, in which an electronic shutter is executed by controlling the voltage Vb without transferring signal charge via a transfer transistor, makes faster operation possible. Further, not needing to separately provide a transfer transistor or other components in each pixel 10 is advantageous to finer pixels.

Although the foregoing has described, as the normal imaging driving, a case where the imaging device 100 is driven by the global shutter method, the imaging device 100 may be driven by the rolling shutter method in the normal imaging driving. In this case, for example, the voltage Ve is constantly applied to the counter electrode 12. Further, in each pixel 10, a reset operation ends when the exposure period starts, and the subsequent readout operation starts when the exposure period ends. For example, in a case where the reset operation and the readout operation are performed at timings shown in FIG. 8, the exposure period of a pixel 10 belonging to the R0th row lasts from time t1 to time t15.

### Current Measurement Circuit

Next, the current measurement circuit 19, which measures an electric current flowing through the photoelectric converter 13, is described. In the imaging device 100, which takes a normal image as noted above, the current change detection circuit 130 can also detect a change in the electric current, measured by the current measurement circuit 19, that flows through the photoelectric converter 13 and detect, based on the change thus detected in the electric current, a moving object that is moving.

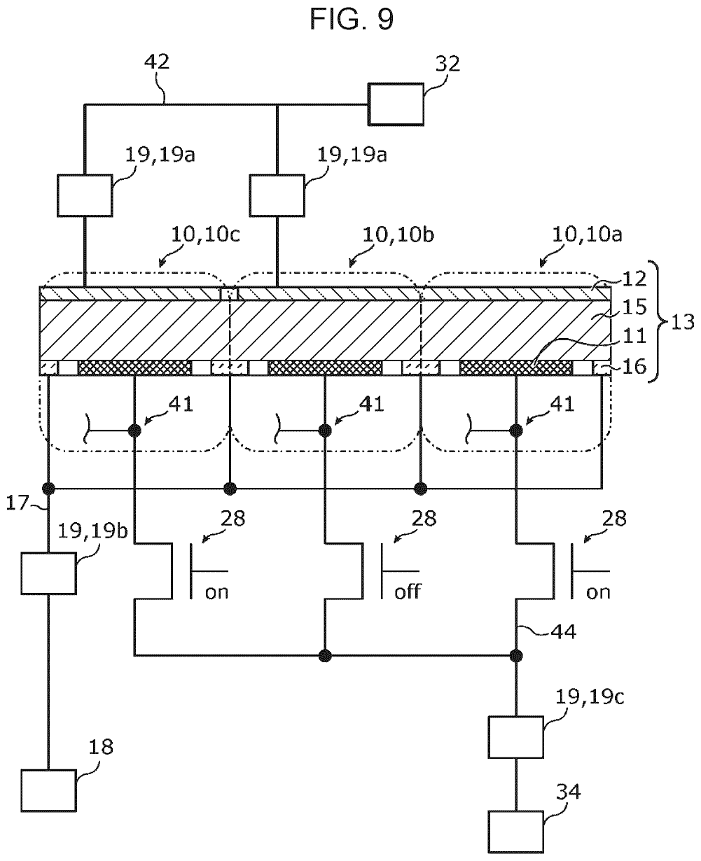

FIG. 9 is a schematic view for explaining the placement of current measurement circuits 19 according to the present embodiment. For ease of viewability, FIG. 9 shows only some constituent elements of the imaging element 110. Further, although FIG. 9 illustrates a plurality of the current measurement circuits 19 for illustrative purposes, the imaging device 100 needs only have at least one current measurement circuit 19. Further, in the description of FIG. 9, these current measurement circuits 19 may be expressed with distinction among current measurement circuits 19a, 19b, and 19c based on the placement. The imaging device 100 needs only have at least one of the current measurement circuits 19a, 19b, and 19c. Further, FIG. 9 shows a diagram corresponding to three of the pixels 10, and the photoelectric converter 13 and the charge storage node 41 of each pixel 10 are surrounded and indicated by a dot-and-dash line. Further, in the description of FIG. 9, the three pixels 10 may be expressed with distinction among pixels 10a, 10b, and 10c in this order from the right.

The current measurement circuit 19 is placed on a wire connected to the photoelectric converter 13 and measures the electric current flowing through the photoelectric converter 13. In the present embodiment, since the photoelectric converter 13 has the counter electrode 12, the shield electrode 16, and the pixel electrode 11 as electrodes that are connected to the wire, the current measurement circuits 19a, 19b, and 19c are connected to any of these electrodes. The current measurement circuit 19a is an example of a first current measurement circuit and is a current measurement circuit that is connected to the counter electrode 12. The current measurement circuit 19b is an example of a second current measurement circuit and is a current measurement circuit that is connected to the shield electrode 16. The current measurement circuit 19c is an example of a third current measurement circuit and is a current measurement circuit that is connected to the pixel electrode 11.

The current measurement circuit 19a is connected to the counter electrode 12. In the example shown in FIG. 9, the current measurement circuit 19a is also connected to the voltage supply circuit 32 and provided in a wiring path connecting the voltage supply circuit 32 with the counter electrode 12, i.e. in the middle of the sensitivity control line 42. Therefore, the current measurement circuit 19a measures an electric current flowing between the counter electrode 12 and the voltage supply circuit 32 and thereby measures the electric current flowing through the photoelectric converter 13. This makes it possible to utilize an existing wire to measure the electric current flowing through the photoelectric converter 13, thus making it possible to inhibit pixel circuits from becoming complex and make the pixels 10 finer. Further, since the current measurement circuit 19a is, for example, connected to the common counter electrode 12 of two or more pixels 10, the current measurement circuit 19a can measure an electric current of the photoelectric converter 13 across the two or more pixels 10, and an increase in the electric current to be measured makes it possible to increase the accuracy of detecting the change in the electric current. It should be noted that the current measurement circuit 19a may be placed within the voltage supply circuit 32. That is, the current measurement circuit 19a may be part of the voltage supply circuit 32.

Further, in the example shown in FIG. 9, the counter electrode 12 is divided into two portions, and individual current measurement circuits 19a are connected separately to each of the two portions of the counter electrode 12. That is, the imaging device 100 includes a plurality of the current measurement circuits 19a that measure electric currents flowing through the photoelectric converters 13 of pixels 10 differing from each other. Therefore, electric currents flowing through the photoelectric converters 13 can be measured separately for each of the areas of the pixels 10 that correspond to the two portions of the counter electrode 12. In the example shown in FIG. 9, electric currents flowing through the photoelectric converters 13 of the pixels 10a and 10b and an electric current flowing through the photoelectric converter 13 of the pixel 10c can be individually measured. The counter electrode 12 does not need to be divided, and in this case, there may be only one current measurement circuit 19a.

The current measurement circuit 19b is connected to the shield electrode 16 as noted above. In the example shown in FIG. 9, the current measurement circuit 19b is also connected to the shield voltage supply circuit 18 and provided in a wiring path connecting the shield voltage supply circuit 18 with the shield electrode 16, i.e. in the middle of the shield line 17. Therefore, the current measurement circuit 19b measures an electric current flowing between the shield electrode 16 and the shield voltage supply circuit 18 and thereby measures the electric current flowing through the photoelectric converter 13. This makes it possible to utilize an existing wire to measure the electric current flowing through the photoelectric converter 13, thus making it possible to inhibit pixel circuits from becoming complex and make the pixels 10 finer. Further, since the current measurement circuit 19b is, for example, connected to the common shield electrode 16 of two or more pixels 10, the current measurement circuit 19b can measure an electric current of the photoelectric converter 13 across the two or more pixels 10, and an increase in the electric current to be measured makes it possible to increase the accuracy of detecting the change in the electric current. It should be noted that the current measurement circuit 19b may be placed within the shield voltage supply circuit 18. That is, the current measurement circuit 19b may be part of the shield voltage supply circuit 18.

Further, although, in the example shown in FIG. 9, there is only one current measurement circuit 19b, the shield electrode 16 may be divided into a plurality of portions as in the case of the counter electrode 12, and individual current measurement circuits 19b may be connected separately to each of the plurality of portions of the shield electrode 16. In a case where a plurality of the current measurement circuits 19b are provided, a first wiring path connecting the shield electrode 16 of the pixel 10a with the shield voltage supply circuit 18 includes a part that does not overlap a second wiring path connecting the shield electrode 16 of the pixel 10c, which is different from the pixel 10a, with the shield voltage supply circuit 18, and the second wiring path includes a part that does not overlap the first wiring path; and in each of these parts, a corresponding one of the plurality of current measurement circuits 19b may be provided. For example, the shield line 17 may branch off into a plurality of portions from the shield voltage supply circuit 18 toward the respective shield electrodes 16 of two or more pixels 10, and current measurement circuits 19b corresponding respectively to the plurality of portions of the shield electrode 17 may be provided. These individual current measurement circuits 19b individually measure electric currents flowing through two or more pixel regions divided from each other, e.g. a pixel region including the pixel 10a and a pixel region including the pixel 10c.

The current measurement circuit 19c is connected to the pixel electrode 11 via the reset transistor 28 and the charge storage node 41. Further, the current measurement circuit 19c is also connected to the reset voltage source 34 and provided in a wiring path connecting the reset voltage source 34 with the pixel electrode 11, i.e. in the middle of the reset voltage line 44. Therefore, the current measurement circuit 19c measures an electric current flowing between the pixel electrode 11 and the reset voltage source 34 and thereby measures the electric current flowing through the photoelectric converter 13. This makes it possible to utilize an existing wire to measure the electric current flowing through the photoelectric converter 13, thus making it possible to inhibit pixel circuits from becoming complex and make the pixels 10 finer. Further, the current measurement circuit 19c can measure an electric current of the photoelectric converter 13 across two or more pixels 10, and an increase in the electric current to be measured makes it possible to increase the accuracy of detecting the change in the electric current. Further, since the pixel electrode 11 is connected to the reset transistor 28 via the charge storage node 41, the electric current flowing through the photoelectric converter 13 is detected by bringing the reset transistor 28 into an on-state so that an electric current can flow through the current measurement circuit 19c. It should be noted that the current measurement circuit 19c may be placed within the reset voltage source 34. That is, the current measurement circuit 19c may be part of the reset voltage source 34.

Further, although, in the example shown in FIG. 9, there is only one current measurement circuit 19c, a plurality of the current measurement circuits 19c may be placed. In the case, a first wiring path connecting the charge storage node 41 of the pixel 10a with the reset voltage source 34 includes a part that does not overlap a second wiring path connecting the charge storage node 41 of the pixel 10c, which is different from the pixel 10a, with the reset voltage source 34, and the second wiring path includes a part that does not overlap the first wiring path; and in each of these parts, a corresponding one of the plurality of current measurement circuits 19c may be provided. For example, the reset voltage line 44 may branch off into a plurality of portions from the reset voltage source 34 toward the respective charge storage nodes 41 of two or more pixels 10, and current measurement circuits 19c corresponding respectively to the plurality of portions of the reset voltage line 44 may be provided. These individual current measurement circuits 19c individually measure electric currents flowing through two or more pixel regions divided from each other, e.g. a pixel region including the pixel 10a and a pixel region including the pixel 10c.

Further, since the reset transistor 28 can switch between being on and being off, for example, turning on the reset transistor 28 on for each row or each column allows the current measurement circuit 19c to detect an electric current flowing through the photoelectric converter 13 of only a pixel 10 that corresponds to the reset transistor 28 thus turned on. Usable examples of the current measurement circuit 19 include, but are not

limited to, measurement circuits for use in publicly-known ammeters such as measurement circuits utilizing shut resistors or measurement circuits utilizing magnetic fields. Specifically, the current measurement circuit 19 includes, for example, a shunt resistor, an amplifying circuit that amplifies a potential difference generated in the shunt resistor, and an AD conversion circuit that AD-converts output from the amplifying circuit, and outputs values AD-converted at predetermined sampling intervals. Further, the current measurement circuit 19 may further include an integrator for holding a peak of the output from the amplifying circuit. In this case, the AD conversion circuit AD-converts the output from the amplifying circuit integrated by the integrator and resets the integrator at predetermined intervals. This makes it possible to, even in a case where there is a change in an electric current only in a period of time between samplings of AD conversion, hold and output the value of the electric current thus changed. This makes it easier to detect the change in the electric current even with longer sampling intervals of AD conversion. This also makes it possible to detect a change in an electric current caused in a short period of time such as a period of time that is shorter than a one-frame period.

Further, the number of current measurement circuits 19 is, for example, smaller than the number of pixels 10. That is, one current measurement circuit 19 is commonly provided for two or more pixels 10 and can measure an electric current flowing through a photoelectric converter 13 of a pixel region including the two or more pixels 10. This makes it possible to reduce the sizes of circuits of the imaging device 100 and reduce power consumption in an operation of detecting a change in the electric current flowing through the photoelectric converter 13. Further, the amount of current that is measured by the current measurement circuit 19 increases, so that it becomes easier to detect the change in the electric current.

### Operation of Current Change Detection by Imaging Device

Next, as an operation of the imaging device 100, an operation in which a moving object is detected by detecting a change in an electric current flowing through the photoelectric converter 13 is described with reference to FIG. 9 and Figs, 10A and 10B, which will be described later. Driving of the imaging device 100 in a mode in which the current change detection circuit 130 detects a change in an electric current flowing through the photoelectric converter 13 as explained below is sometimes referred to as “current change detection driving”. Further, since the current change detection circuit 130 can detect a moving object based on the change thus detected in the electric current, the current change detection driving may also be called “moving object detection driving”. First, in the current change detection driving, for example, the voltage Vb, which is supplied from the voltage supply circuit 32, is supplied in such a way as to be lower or higher than a shield voltage Vs that is supplied from the shield voltage supply circuit 18 and the reset voltage Vr, which is supplied from the reset voltage source 34. That is, a voltage is supplied from each voltage supply circuit so that there is a potential difference between two electrodes facing each other across the photoelectric conversion layer 15. As a specific example, the voltage Vb, the shield voltage Vs, and the reset voltage Vr are set at 10 V, 0 V, and 1 V, respectively, and supplied. This results in the occurrence of photoelectric conversion in the photoelectric converter 13 when light falls on the photoelectric converter 13, thus causing an electric current to flow through the photoelectric converter 13, so that the electric current flowing through the photoelectric converter 13 is measured by current measurement circuits 19 connected to the respective electrodes. As a result of measuring the electric current, for example, the current measurement circuits 19 output AD-converted digital values to the current change detection circuit 130. At this point in time, for increased sensitivity of detection of a change in the electric current by the current change detection circuit 130, the voltage Vb, the shield voltage Vs, and the reset voltage Vr may be set so that the difference between the voltage Vb and the shield voltage Vs and the difference between the voltage Vb and the reset voltage Vr become greater than they are during the normal imaging driving.

In a case where the current measurement circuit 19a measures the electric current, either the difference between the voltage Vb and the shield voltage Vs or the difference between the voltage Vb and the reset voltage Vr may be greater than the other. Further, in a case where the current measurement circuit 19b measures the electric current, the difference between the voltage Vb and the shield voltage Vs may be greater than the difference between the voltage Vb and the reset voltage Vr. This makes it easier for the electric current to flow through the shield electrode 16. As a specific example of this case, the voltage Vb, the shield voltage Vs, and the reset voltage Vr are 10 V, 0 V, and 3 V, respectively. Further, in a case where the current measurement circuit 19c measures the electric current, the difference between the voltage Vb and the reset voltage Vr may be greater than the difference between the voltage Vb and the shield voltage Vs. This makes it easier for the electric current to flow through the pixel electrode 11. As a specific example of this case, the voltage Vb, the shield voltage Vs, and the reset voltage Vr are 10 V, 4 V, and 0.5 V, respectively.

Next, the current change detection circuit 130 acquires output form the current measurement circuit 19 and detects a change in the electric current, measured by the current measurement circuit 19, that flows through the photoelectric converter 13. A change in the amount of light that falls in the photoelectric converter 13 causes a change in the quantity of electric charge that is generated by the photoelectric converter 13, causing a change in the electric current flowing through the photoelectric converter 13. For example, by detecting whether a change greater than or equal to a predetermined threshold has occurred in the output from the current measurement circuit 19, the current change detection circuit 130 detects a change in the electric current, measured by the current measurement circuit 19, that flows through the photoelectric converter 13. The change in the electric current detected by the current change detection circuit 130 herein indicates a change that satisfies a predetermined condition, such as a change greater than or equal to a threshold, and means a substantial change. The change in the electric current detected by the current change detection circuit 130 does not encompass a change in the electric current attributed to a change in a voltage that is supplied to the photoelectric converter 13, such as changes in voltages that are supplied by various voltage supply circuits that supply voltages to the photoelectric converter 13. That is, the current change detection circuit 130 detects a temporal change in the electric current attributed to a change in the amount of light that falls on the photoelectric converter 13.

Further, detection of a change in the electric current by the current change detection circuit 130 may be performed by making a comparison with a previous value of output every sampling of AD conversion by the current measurement circuit 19 or may be performed by making a comparison with the average of values of output sampled a predetermined number of times. Further, in a case where the current measurement circuit 19 includes an integrator, the current change detection circuit 130 detects a change in the electric current by comparing differences between values of output from the current measurement circuit 19. Further, in the case of an application, such as a surveillance application, in which a background is fixed, the current change detection circuit 130 may detect a change in the electric current according to whether the output by the current measurement circuit 19 is out of a predetermined range.

An analog signal may be outputted from the current measurement circuit 19 to the current change detection circuit 130. In this case, the current change detection circuit 130 may have an AD conversion circuit that AD-converts the analog signal and may have a comparator that temporarily stores the analog signal and compares it with the previous and next analog signals.

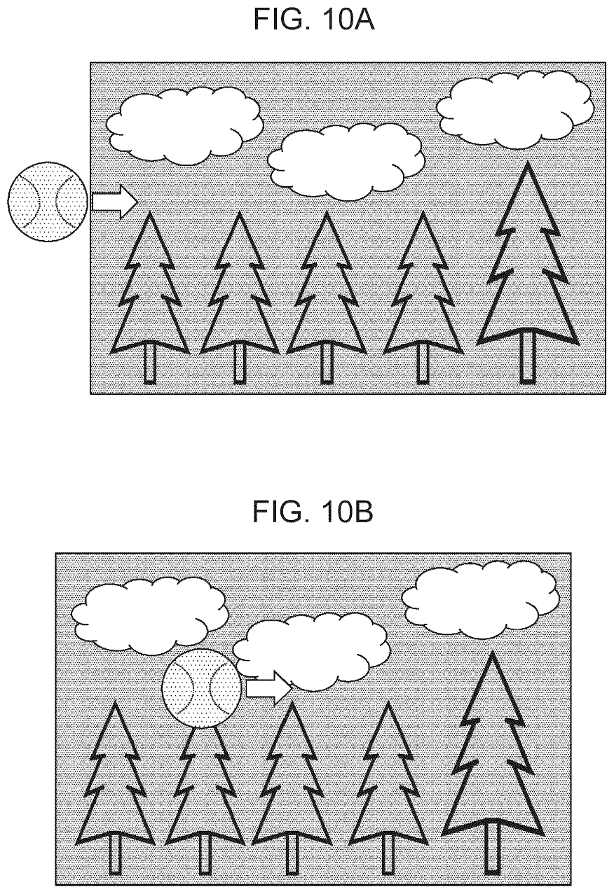

FIGS. 10A and 10B are diagrams for explaining specific examples of an operation of current change detection driving in the imaging device 100 according to the present embodiment and detection results.

FIGS. 10A and 10B show, as an example, a scene in which there is a background present in the range of imaging of the imaging device 100 and a ball flying from outside the range of imaging passes transversely across the range of imaging. FIG. 10A shows a state where the ball comes from outside the range of imaging into the range of imaging, and FIG. 10B shows a state where the ball is passing transversely across the range of imaging.

In a case where the ball comes into the range of imaging as shown in FIG. 10A and the ball is brighter than the background, an electric current that flows due to photoelectric conversion in the photoelectric converter 13 based on light from the ball is larger than an electric current that flows due to photoelectric conversion in the photoelectric converter 13 based on light from a portion of the background that falls within the same range as the ball. As a result of that, an electric current that flows through the photoelectric converter 13 after the ball has come into the range of imaging further increases than does an electric current that flows through the photoelectric converter 13 at a point in time before the ball passes transversely across the range of imaging, so that there is a change in the electric current flowing through the photoelectric converter 13. Therefore, by detecting a change in the electric current measured by the current measurement circuit 19, the current change detection circuit 130 can detect the presence of a moving object such as a ball having come into the range of imaging.

Further, in a case, such as that shown in FIG. 10B, where the ball moves within the range of imaging, light from the background is blocked by the ball and there is a change in the amount of light from the background that falls on the photoelectric converter 13, so that there is a change in the electric current flowing through the photoelectric converter 13. For example, in a case where a gray ball has passed transversely across a portion of the background, such as a cloud, that has a high light reflectivity, the electric current flowing through the photoelectric converter 13 becomes less than it is before the ball passes transversely across the cloud. Therefore, by detecting a change in the electric current measured by the current measurement circuit 19, the current change detection circuit 130 can detect the presence of a moving object within the range of imaging.

For example the current change detection circuit 130 generates, based on the change thus detected in the electric current, a detection signal pertaining to the moving object moving within the range of imaging. The detection signal is a signal that indicates whether the moving object is present. The detection signal may contain information pertaining to the amount of change in the electric current as detected by the current change detection circuit 130. The detection signal generated by the current change detection circuit 130 is, for example, outputted to the drive control circuit 140 for use in control of drive of the imaging device 100 by the drive control circuit 140. Further, the detection signal may be outputted to a device external to the imaging device 100.

Further, the description given with reference to FIGS. 10A and 10B means that, for example, even in a case where one current measurement circuit 19a is connected to an undivided counter electrode 12, a moving object can be detected by the current change detection circuit 130. Furthermore, in a case where the counter electrode 12 or other electrodes are divided for each pixel region constituted by several pixels 10 and a change in an electric current can be detected in a plurality of the pixel regions, the moving object can be detected with a higher degree of accuracy.

Thus, even in case where a moving object has come from outside the range of imaging of the imaging device 100 into the range of imaging and a case where the moving object has moved within the range of imaging of the imaging device 100, light from a background is blocked by the moving object, whereby a change in the amount of light that falls on the photoelectric converter 13 causes a change in an electric current flowing through the photoelectric converter 13 to appear. Therefore, both a bright moving object and a dark moving object can be detected by the current change detection circuit 130 detecting a change in the electric current measured by the current measurement circuit 19.

Further, in a case where the current measurement circuit 19c measures an electric current, detection of a moving object is enabled by the current change detection circuit 130 by, with the reset transistor 28 turned on, the current measurement circuit 19c measuring an electric current flowing through a wire connecting the reset voltage source 34 with the reset transistor 28. In this case, detection of a moving object in any region within the range of imaging is enabled according to which pixel 10 has its reset transistor 28 turned on. Further, hourly changing regions of pixels 10 having their reset transistors 28 turned on makes it possible to detect a moving object in all regions within the range of imaging while detecting a moving object in any region within the range of imaging.

Further, also in a case where the current measurement circuits 19a and 19b measure an electric current, the counter electrode 12 and the shield electrode 16 may be divided, and the range of imaging may be divided into regions. This makes it possible to detect a moving object for each region with the current change detection circuit 130. For example, when the counter electrode 12 is divided into four regions, namely an upper left region, an upper right region, a lower right region, and a lower left region, in which of the four regions the moving object is present can be detected.

Further, generally, in the case of being used outdoors in the daytime, there can be a luminance change in ambient light such as sunlight; therefore, in anticipation of such a luminance change, the current change detection circuit 130 may have set therefor a condition for detecting a change in the electric current flowing through the photoelectric converter 13. Specific examples include setting a threshold for detection high in advance, analyzing a frequency component of a change in the electric current that corresponds to the luminance change in the ambient light and extracting and detecting only a change in the electric current due to the moving object, and using a plurality of current measurement circuits 19 to detect and extract a change in the electric current due to the moving object while setting off, from electric currents measured by the respective current measurement circuits 19, the change in the electric current derived from the ambient light.

Meanwhile, the accuracy of detecting the moving object with the current change detection circuit 130 in the nighttime, indoors, or other situations is high. This is because normal indoor lighting has a small luminance change and is hardly affected by ambient light, such as sunlight, that has a large luminance change. The same applies to the nighttime. Further, in the nighttime, the accuracy of detecting the moving object can be further increased by using a lighting device 200 that emits light containing near infrared radiation.

### Drive Mode Control

Next, drive mode control by the drive control circuit 140 is described. The drive control circuit 140 controls the imaging device 100, for example, so that the imaging device 100 performs current change detection driving and normal imaging driving. As mentioned above, the current change detection driving is a drive mode in which the current change detection circuit 130 detects a change in the electric current flowing through the photoelectric converter 13, and the normal imaging driving is a drive mode in which the signal detection circuit 14 detects a pixel signal based on the electric charge generated by the photoelectric converter 13. The drive control circuit 140 may cause the imaging device 100 to switch between performing the current change detection driving and performing the normal imaging driving or may cause the imaging device 100 to perform the current change detection driving and the normal imaging driving simultaneously.

For example, in a case where, while the imaging device 100 is operating in the current change detection driving, the current change detection circuit 130 detects the change in the electric current flowing through the photoelectric converter 13, the drive control circuit 140 switches the drive mode from the current change detection driving to the normal imaging driving. In so doing, the current change detection circuit 130 may detect the moving object by detecting the change in the electric current. Doing so makes it possible to, in the current change detection driving, bring the imaging device 100 into operation without causing circuits for use in normal imaging to be driven as in the case of the normal imaging driving, thus making it possible to reduce power consumption. This also enable considerations for privacy even in a case where the imaging device 100 is used in a surveillance application.

For example, while the drive control circuit 140 is controlling the imaging device 100 so that the imaging device 100 performs the current change detection driving, the drive control circuit 140 may bring, into an off-state or a stand-by state, at least some of the signal detection circuit 14 and circuits that are connected to the signal detection circuit 14. The circuits that are connected to the signal detection circuit 14 are circuits responsible for outputting pixel signals, and examples of the circuits include circuits such as the vertical scanning circuit 36 that drive the signal detection circuit 14 and circuits such as the column signal processing circuits 37 and the horizontal signal readout circuit 38 that process pixel signals outputted from the signal detection circuit 14. The off-state of the circuits is a state where the supply of electric power is shut off by a switch or other devices provided in each circuit. Further, the stand-by state of the circuits is a state where at least some of the circuits do not work while electric power is supplied, a state where at least some of the circuits work on lower power than usual, or other states. The stand-by state is, for example, a state where less electric power is consumed than in the normal imaging driving. Therefore, in the current change detection driving, for example, at least some circuit elements are not driven in the signal detection circuit 14, or signal processing is not performed on pixel signals detected by the signal detection circuit 14. As a result of that, in the current change detection driving, signals derived from pixel signals are not outputted to a device external to the imaging device 100.

Meanwhile, once the change in the electric current is detected, i.e. once the moving object is detected, by the current change detection circuit 130, the imaging device 100 is brought into the normal imaging driving and can output an image containing more detailed information pertaining to the subject.

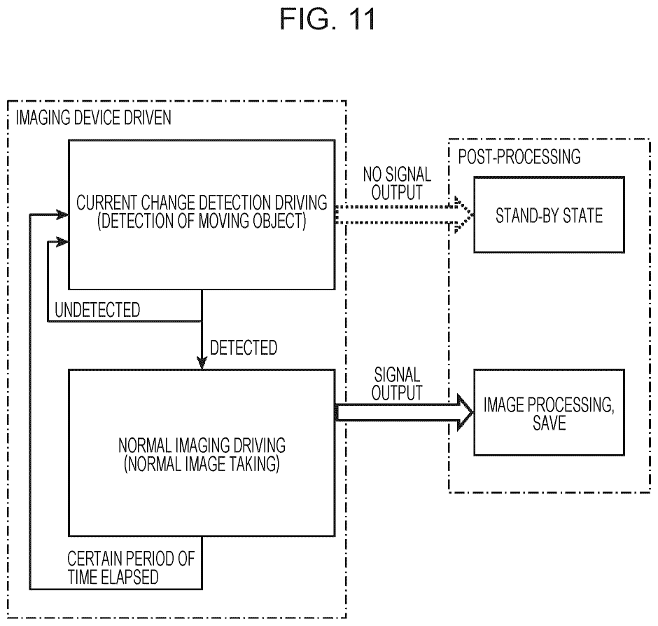

FIG. 11 is a diagram for explaining a first example of drive mode control in the imaging device 100 according to the present embodiment. As shown in FIG. 11, in the first example, first, the drive control circuit 140 causes the imaging device 100 to perform the current change detection driving. In this occasion of current change detection driving, no signal is outputted to a device external to the imaging device 100. Therefore, the image processor 300 or other devices that perform post-processing on output from the imaging device 100 do not need to perform image processing or other processes and, for example, are in a stand-by state. This makes it possible to reduce power consumption in post-processing. This also makes it possible to reduce the volume of saved images. In this case, the image processor 300 or other devices that perform post-processing on output from the imaging device 100 may be in an off-state.

Further, in the current change detection driving, for example, the current change detection circuit 130 generates, based on whether there is a change in the electric current, measured by the current measurement circuit 19, that flows through the photoelectric converter 13, a detection signal indicating whether a moving object is present within the range of imaging, and outputs the detection signal to the drive control circuit 140. Further, the current change detection circuit 130 may generate a detection signal only in a case where the current change detection circuit 130 has detected a change in the electric current flowing through the photoelectric converter 13, and does not need to generate a detection signal in a case where the current change detection circuit 130 has not detected a change in the electric current. In the current change detection driving, the detection signal may be outputted to a device external to the imaging device 100 such as the image processor 300.

The drive control circuit 140 continues the current change detection driving in a case where the change in the electric current flowing through the photoelectric converter 13 has not been detected by the current change detection circuit 130. Meanwhile, the drive control circuit 140 switches the drive mode from the current change detection driving to the normal imaging driving in a case where the change in the electric current flowing through the photoelectric converter 13 has been detected by the current change detection circuit 130. In the normal imaging driving, a signal containing image data is outputted to a device external to the imaging device 100. For example, in the normal imaging driving, the image processor 300 or other devices that perform post-processing on output from the imaging device 100 perform image processing, saves, or other processes on the image data outputted from the imaging device 100. That is, in the normal imaging driving, it is possible to acquire a detailed image.

The drive control circuit 140 switches the drive mode from the normal imaging driving to the current change detection driving after a predetermined period of time has elapsed since the imaging device 100 started the normal imaging driving. This enables the imaging device 100 to be driven with low power consumption. Further, after switching to the current change detection driving, the aforementioned operation is performed again.

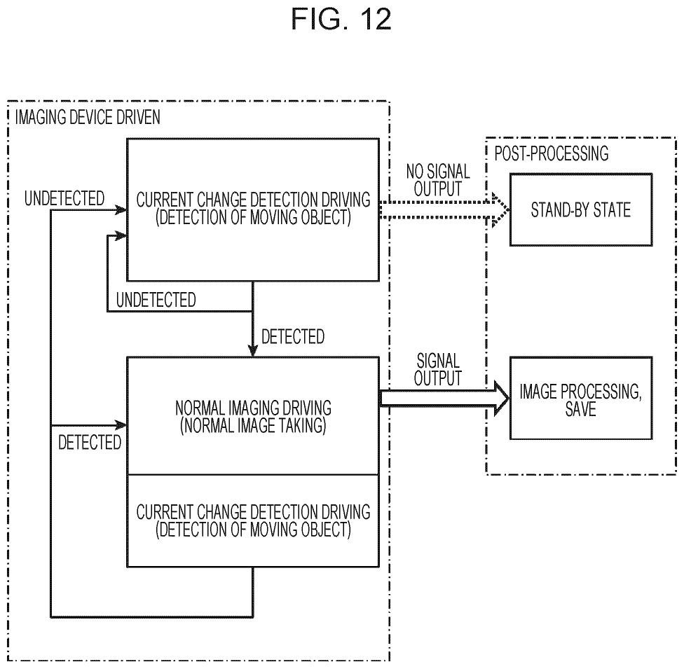

Further, while causing the imaging device 100 to perform the normal imaging driving, the drive control circuit 140 may cause the imaging device 100 to perform the current change detection driving simultaneously. FIG. 12 is a diagram for explaining a second example of drive mode control in the imaging device 100 according to the present embodiment. The second example shown in FIG. 12 is the same as the aforementioned first example in that, first, the drive control circuit 140 causes the imaging device 100 to perform only the current change detection driving and, in a case where the change in the electric current flowing through the photoelectric converter 13 has been detected by the current change detection circuit 130, causes the imaging device 100 to switch to performing the normal imaging driving. As shown in FIG. 12, in the second example, while causing the imaging device 100 to perform the normal imaging driving, the drive control circuit 140 causes the imaging device 100 to perform the current change detection driving simultaneously in parallel. The drive control circuit 140 continues the normal imaging driving in a case where the change in the electric current flowing through the photoelectric converter 13 has been detected by the current change detection circuit 130 in the current change detection driving during the normal imaging driving. Meanwhile, the drive control circuit 140 switches from simultaneously performing the normal imaging driving and the current change detection driving to performing only the current change detection driving in a case where the change in the electric current flowing through the photoelectric converter 13 has been detected by the current change detection circuit 130 in the current change detection driving during the normal imaging driving. In this case, detection of the change in the electric current flowing through the photoelectric converter 13 is performed even during the normal imaging driving, switching to a drive mode in which only the current change detection driving is performed is done in a case where the moving object is no longer present. This makes it possible to reduce power consumption and also reduce the volume of saved images. Meanwhile, as long as the moving object is present, images can be acquired at all times, so that images of the moving object can be taken in a seamless way.

In the case of the second example, the signal charge stored in the charge storage node 41 connected to the pixel electrode 11 is used for detecting a pixel signal, the electric current flowing through the photoelectric converter 13 cannot be measured even by measuring the electric current with the current measurement circuit 19c having a connection to the charge storage node 41. Therefore, the current change detection circuit 130 detects the change in the electric current measured by the current measurement circuit 19a connected to the counter electrode 12 or the current measurement circuit 19b connected to the shield electrode 16. Further, in this case, from the point of view of making it easier to detect the change in the electric current flowing through the photoelectric converter 13 in order to detect the moving object, the drive control circuit 140 may, in the normal imaging driving, drive the imaging device 100 in the rolling shutter method, in which there is no changes in the voltages that the voltage supply circuit 32 and the shield voltage supply circuit 18 supply. Further, in a case where the imaging device 100 is driven in the global shutter method, for example, the current change detection circuit 130 detects, at a timing other than the timing of a change in a voltage that is supplied to the photoelectric converter 13 by the voltage supply circuit 32 or other circuits, the change in the electric current measured by the current measurement circuit 19.

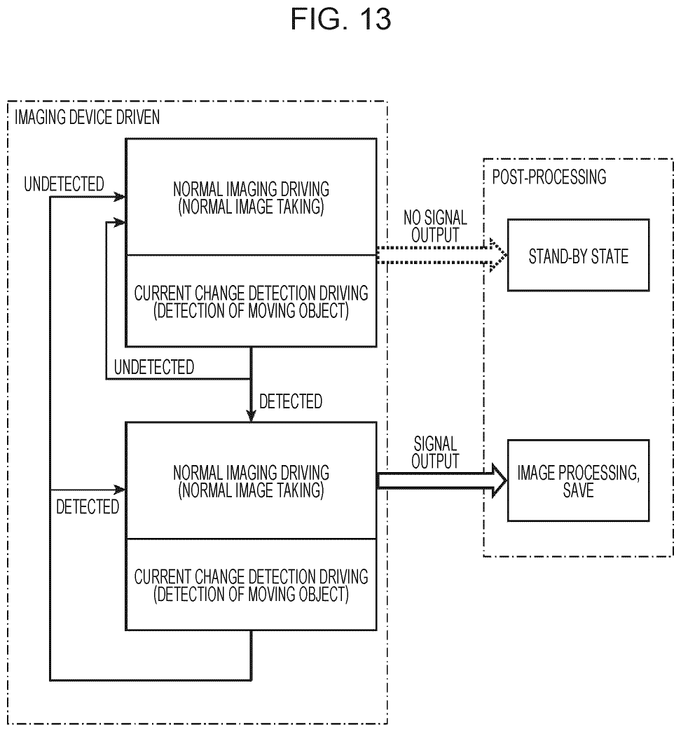

Further, regardless of whether the change in the electric current flowing through the photoelectric converter 13 is being detected by the current change detection circuit 130, the drive control circuit 140 may cause the imaging device 100 to always perform the current change detection driving and the normal imaging driving simultaneously. FIG. 13 is a diagram for explaining a third example of drive mode control in the imaging device 100 according to the present embodiment. As shown in FIG. 13, in the third example, the drive control circuit 140 controls the imaging device 100 so that the imaging device 100 performs the current change detection driving and the normal imaging driving simultaneously. That is, in the third example, the operation subsequent to the detection of the change in the electric current flowing through the photoelectric converter 13 in the second example is always performed. In this way, the detection of the moving object and the taking of a normal image are always performed simultaneously. In this case, a signal containing image data generated by the normal imaging driving is outputted to a device external to the imaging device 100 by the imaging device 100 only in a case where, in the current change detection driving, the current change detection circuit 130 is detecting the change in the electric current flowing through the photoelectric converter 13. The image processor 300 or other devices that perform post-processing on output from the imaging device 100 perform image processing, saves, or other processes on the image data outputted from the imaging device 100.

Meanwhile, in a case where, in the current change detection driving, the current change detection circuit 130 has not detected the change in the electric current flowing through the photoelectric converter 13, the imaging device 100 outputs no signal to a device external to the imaging device 100. Therefore, the image processor 300 or other devices that perform post-processing on output from the imaging device 100 do not need to perform image processing or other processes and, for example, are in a stand-by state. This makes it possible to reduce power consumption in post-processing and also reduce the volume of saved images.

Further, in the third example, a detection signal, generated by the current change detection circuit 130, that indicates whether the moving object has been detected (or whether the change in the electric current has been detected) may be outputted to a device external to the imaging device 100 such as the image processor 300. With this, in a case where the moving object has been detected, data indicating the detection of the moving object can be added in post-processing to the image to be saved. Further, in a case where the moving object has not been detected, the imaging device 100 may output, to a device external to the imaging device 100, the detection signal and a signal containing image data or other data. Upon receiving output from the imaging device 100, for example, the image processor 300 or other devices save images with one image decimated every ten seconds in a case where the moving object has not been detected and always save images in a case where the moving object has been detected.

Further, in a case where a pixel region in which to measure the electric current flowing through the photoelectric converter 13 is divided, such as a case where the counter electrode 12 is divided, the current change detection circuit 130 may limit, in the current change detection driving, a pixel region in which to perform detection of the moving object. For example, in the case of imaging of an object such as a light whose luminance varies, a flag flapping in the wind, or other objects, there can be a change in the electric current flowing through the photoelectric converter 13 as in the case of the moving object. These objects may be detected as moving object and bring about a state where a moving object is always detected. In this case, a pixel region in which the moving object is to be detected may be set with the preliminary exclusion of a pixel region in which an object such as a light whose luminance varies, a flag flapping in the wind, or other objects are present. In this way, in the current change detection driving, the current change detection circuit 130 can generate a detection signal pertaining to the moving object by, without detecting, as the moving object, an object that is not actually moving or other objects, detecting the moving object actually moving. Therefore, unintended detection of the moving object is inhibited, and reductions in power consumption of the imaging device 100 and the camera system 1 can be expected. For example, the current change detection circuit 130 may detect whether the moving object is present, with the exclusion of, from the pixel region in which the moving object is to be detected, a pixel region in which the change in the electric current has continued for a predetermined period of time.

### Other Embodiments

While the foregoing has described an imaging device and a camera system according to the present disclosure with reference to embodiments, the present disclosure is not intended to be limited to these embodiments.

Further, although, in the foregoing embodiment, the signal detection transistor 24, the address transistor 26, and the reset transistor 28 are N-channel MOSFETs, this is not intended to impose any limitation. The signal detection transistor 24, the address transistor 26, and the reset transistor 28 may be P-channel MOSFETs. All these do not need to be uniformly either N-channel MOSFETs or P-channel MOSFETs. Further, the signal detection transistor 24 and/or the address transistor 26 may be not a field-effect transistor but another transistor such as a bipolar transistor.

Further, although the foregoing embodiment has illustrated an example in which the current change detection circuit 130 detects a moving object, the current change detection circuit 130 can similarly detect a change in a subject that entails a change in luminance in the range of imaging, such as not only a case where there is a moving object that simply makes a great movement but also a case where an object vibrates, a case where an object flaps like a flag, and a case where an object makes a luminance change like a traffic light. That is, by detecting a change in the electric current measured by the current measurement circuit 19, the current change detection circuit 130 may generate a detection signal pertaining to the change in the subject.

Further, the camera system 1 and the imaging device 100 do not need to include all constituent elements described in the foregoing embodiment and may be composed solely of constituent elements for achieving the intended operation.

For example, the imaging device 100 does not need to include the shield electrode 16, the shield line 17, and the shield voltage supply circuit 18.

Further, in the foregoing embodiment, a process that is executed by a specific processor such as the current change detection circuit 130 and the drive control circuit 140 may be executed by another processor. Further, the order of a plurality of processes may be changed, or the plurality of processes may be executed in parallel.

Further, general or specific embodiments may be implemented as a system, a device, a method, an integrated circuit, a computer program, or a computer-readable storage medium such as a CD-ROM. Further, general or specific embodiments may be implemented as a system, a device, a method, an integrated circuit, a computer program, a storage medium, or any selective combination thereof.

For example, the present disclosure may be implemented as the camera system or the imaging device of the foregoing embodiment, may be implemented as a processing circuit for use in the imaging device having functions of the current change detection circuit, the drive control circuit, or other circuits of the foregoing embodiment, may be implemented as an imaging method of the imaging device that the current change detection circuit, the drive control circuit, or other circuits of the foregoing embodiment perform, may be implemented as a program for causing a computer to execute such an imaging method, or may be implemented as a computer-readable non-transitory storage medium having such a program stored thereon.

In addition, various modifications conceived of by persons skilled in the art are encompassed in the scope of the present disclosure. Further, constituent elements of different embodiments may be arbitrarily combined without departing from the scope of the present disclosure.

An imaging device or other devices according to the present disclosure are applicable, for example, to an image sensor or other sensors. Further, an imaging device or other devices according to the present disclosure can be used in a camera for medical use, a camera for use in a robot, a security camera, a camera that is mounted on a vehicle for use, or other cameras.

What is claimed is:

1. An imaging device comprising:
a photoelectric converter including a first electrode, a second electrode facing the first electrode, and a photoelectric conversion layer located between the first electrode and the second electrode;
a first voltage supply circuit that applies a voltage between the first electrode and the second electrode;
a charge accumulator that is connected to the first electrode and in which electric charge generated by the photoelectric converter is stored;
a signal detection circuit that detects a signal based on the electric charge stored in the charge accumulator;
at least one current measurement circuit that measures an electric current flowing through the photoelectric converter; and
a current change detection circuit that detects a change in the electric current, the electric current flowing through the photoelectric converter and being measured by the at least one current measurement circuit.

2. The imaging device according to claim 1, wherein
the first voltage supply circuit applies the voltage between the first electrode and the second electrode by supplying a predetermined voltage to the second electrode, and
the at least one current measurement circuit includes at least one first current measurement circuit connected to the second electrode.

3. The imaging device according to claim 2, wherein
the second electrode is divided into a plurality of sub-second electrodes,
the at least one first current measurement circuit includes a plurality of first current measurement circuits, and
each of the plurality of sub-second electrodes is connected to a corresponding one of the plurality of first current measurement circuits.

4. The imaging device according to claim 1, wherein
the photoelectric converter further includes a third electrode facing the second electrode across the photoelectric conversion layer, and
the at least one current measurement circuit includes at least one second current measurement circuit connected to the third electrode.

5. The imaging device according to claim 4, wherein
the third electrode is divided into a plurality of sub-third electrodes,
the at least one second current measurement circuit includes a plurality of second current measurement circuits, and
each of the plurality of sub-third electrodes is connected to a corresponding one of the plurality of second current measurement circuits.

6. The imaging device according to claim 1, further comprising a second voltage supply circuits that supplies a predetermined voltage to the charge accumulator,
wherein the at least one current measurement circuit includes at least one third current measurement circuit connected to the second voltage supply circuit.

7. The imaging device according to claim 6, further comprising a plurality of pixels, wherein
each of the plurality of pixels includes the photoelectric converter, the signal detection circuit, and the charge accumulator,
the at least one third current measurement circuit includes a plurality of third current measurement circuits,
the plurality of pixels include a first pixel and a second pixel different from the first pixel,
the imaging device further comprises a first wiring path and a second wiring path, the first wiring path connecting the charge accumulator included in the first pixel with the second voltage supply circuit, the second wiring path connecting the charge accumulator included in the second pixel with the second voltage supply circuit,
the first wiring path includes a first part that does not overlap the second wiring path,
the second wiring path includes a second part that does not overlap the first wiring path, and
a corresponding one of the plurality of third current measurement circuits is located in each of the first part and the second part.

8. The imaging device according to claim 1, wherein the at least one current measurement circuit includes a plurality of current measurement circuits.

9. The imaging device according to claim 1, further comprising a plurality of pixels, wherein
each of the pixels includes the photoelectric converter and the signal detection circuit, and
the number of the at least one current measurement circuit is smaller than the number of the plurality of pixels.

10. The imaging device according to claim 1, further comprising a drive control circuit that controls driving of the imaging device,
wherein the drive control circuit controls the imaging device so that the imaging device switches between performing (i) current change detection driving in which the current change detection circuit detects the change in the electric current flowing through the photoelectric converter and performing (ii) normal imaging driving in which the signal detection circuit detects the signal based on the electric charge generated by the photoelectric converter.

11. The imaging device according to claim 10, wherein in a case where the change in the electric current flowing through the photoelectric converter is detected by the current change detection circuit while the imaging device is performing the current change detection driving, the drive control circuit switches the driving of the imaging device from the current change detection driving to the normal imaging driving.

12. The imaging device according to claim 11, wherein the drive control circuit switches the driving of the imaging device from the normal imaging driving to the current change detection driving after a predetermined period of time has elapsed since the imaging device started the normal imaging driving.

13. The imaging device according to claim 10, wherein while the drive control circuit is controlling the imaging device so that the imaging device performs the current change detection driving, the drive control circuit brings, into an off state or a stand-by state, at least some of the signal detection circuit and circuits that are connected to the signal detection circuit.

14. The imaging device according to claim 10, wherein the drive control circuit controls the imaging device so that the imaging device performs the current change detection driving and the normal imaging driving simultaneously.

15. A camera system comprising:
the imaging device according to claim 1; and
a lighting device that emits light containing near infrared radiation.
